(19) United States
(12) Patent Application Publication
(10) Pub. No.: US 2007/0300253 A1
(43) Pub. Date: Dec. 27, 2007

(54) Selecting equipment for audio-visual content

(76) Inventors: Hiroki Kawai, Shiga (JP); Yuji Tanikawa, Osaka (JP)

Correspondence Address: MCDERMOTT WILL & EMERY LLP, 600 13TH STREET, NW, WASHINGTON, DC, 20005-3096, US

(21) Appl. No.: 11/812,703

(22) Filed: Jun. 21, 2007

(30) Foreign Application Priority Data
Jun. 22, 2006 (JP) 2006-172322
Mar. 2, 2007 (JP) 2007-052763

(51) Int. Cl. H04N 5/445; G06F 13/00; H04N 7/16; G06F 3/00

(52) U.S. Cl. 725/38; 725/135; 725/37; 725/39

(57) ABSTRACT

A data separating device separates video data, audio data, and metadata from a multiplexed broadcasting signal. A metadata extracting device extracts program preview property information and original program property information from the metadata. A program preview extracting device extracts a program preview content of an original program preview at least from either the video data or the audio data based on the program preview property information, and records the extracted program preview content on a recording medium as content checking support data. A digest saving/managing device generates at least a single digest by relating the program preview property information, the original program property information, and the content checking support data, and saves/manages the digest.

### BACKGROUND OF THE INVENTION

1. Field of the Invention

The present invention relates to an audio-visual content selecting circuit and an audio-visual content selecting apparatus for supporting viewers in viewing broadcast contents. Further, the present invention also includes a technique to help the viewers to reserve recording or viewing of the broadcast contents. The target broadcasting is all types of broadcasting, but the main target is digital broadcasting. The main target communication media are terrestrial broadcasting and satellite broadcasting that uses satellites. However, cable broadcasting (CATV) and broadcasting using telephone circuits may also be considered the targets.

2. Description of the Related Art

For the current television broadcasting, there are terrestrial broadcasting, satellite broadcasting, cable broadcasting, and the like, which provide viewers with a great number of programs. In addition, it is anticipated that the number of available channels will increase in the future and the number of available programs will continue to increase due to further diversification in the forms of supplying the contents, such as a network distribution system which allows moving picture contents to be viewed by personal computers (PCs) through the Internet and server-type broadcasting whose specifications are currently being formulated in TV-Anytime Forum.

Under such audio-visual viewing environments, it becomes essential to provide services to help viewers select programs. As services for helping the viewers select the programs, provided so far is a program selecting service such as EPG (Electronic Program Guide), which uses a program list expressed on the two axes, i.e., broadcast time zones and channels. The program information displayed in EPG is constituted basically with textual information. Thus, it is difficult to grasp the program contents intuitively through the list. A conventional technique for solving this problem is disclosed in Japanese Published Patent Literature (Japanese Unexamined Patent Publication 2005-159770; referred to as a conventional case hereinafter). FIG. 27 shows a time table depicted in the conventional case.

An apparatus depicted in the conventional case comprises: a device for extracting a preview scene of the next broadcast; a device for recording the extracted preview scene of the next broadcast; a metadata analyzing device for analyzing the metadata and relating it to the original program information; and a program list creating device for creating a program list that is expressed with two axes of broadcast time and channels. The metadata is description of the structural information of contents and other additional information. The metadata of the received broadcast program is identified and the preview scene is recorded and accumulated, and a program preview frame for designating reproduction of the preview moving picture is inserted before an original program frame of EPG. When a viewer operates the EPG to select the program preview frame, the preview scene that corresponds to the original program is reproduced, so that the outline of the program contents can be checked by the moving picture prior to the broadcast of the original program.

The conventional case requires the viewers to perform a plurality of operations for viewing the program preview moving picture, e.g., first, the viewer operates EPG to visually check the program name or the program outline with textual information, and next, select the program preview frame thereafter. When the number of channels and the number of programs increase in accordance with the diversification of the broadcasting forms, the textual information that needs to be displayed in EPG increases. Accordingly, the number of manual operations such as scrolling increases for selecting a desired program. Therefore, a series of program searching operations performed on EPG in the conventional case imposes a great burden on the viewers. Further, recording is constantly continued whether it is for the original program or the program preview, so that the load on the device in the steady state becomes excessive. Furthermore, the capacity of a recording medium needs to be extensive.

### SUMMARY OF THE INVENTION

The main object of the present invention therefore is to provide an audio-visual content selecting circuit and an audio-visual content selecting apparatus, which can lighten the burden of executing the program searching operation imposed on the viewers.

(1) An audio-visual content selecting circuit according to the present invention comprises:

a data separating device which separates video data, audio data, and metadata from a multiplexed broadcasting signal;

a metadata extracting device for extracting program preview property information and original program property information from the metadata;

a program preview extracting device which extracts a program preview content of an original program preview at least from either the video data or the audio data based on the program preview property information, and records the extracted program preview content on a recording medium as content checking support data; and

a digest saving/managing device which generates at least a single digest by relating the program preview property information, the original program property information, and the content checking support data, and saves/manages the digest.

An audio-visual content selecting apparatus that corresponds to the audio-visual content selecting circuit of the above-described structure comprises:

a data separating device which separates video data, audio data, and metadata from a multiplexed broadcasting signal;

a metadata extracting device for extracting program preview property information and original program property information from the metadata;

a program preview extracting device which extracts a program preview content of an original program preview as content checking support data at least from either the video data or the audio data based on the program preview property information;

a digest saving/managing device which generates at least a single digest by relating the program preview property information, the original program property information, and the content checking support data, and saves/manages the digest; and

a content checking support data transfer device for transferring the content checking support data to a recording medium.

In principle, the present invention is directed to program previews which are broadcast contents created by the broadcasting station or the sponsor side after summarizing the contents regarding the original programs, and are broadcasted in the same time zone as that of product promotion CM (commercial message) and the like between an original program and an original program.

In the above-described structure, the metadata separating device separates the video data, the audio data, and the metadata from the broadcasting signal, and the metadata extracting device extracts the program preview property information and the original program property information from the metadata. The extracted program preview property information and original program property information is supplied to the digest saving/managing device. Then, the program preview extracting device extracts program preview data (the program preview video data or the program audio data, or the both) from the video data and the audio data separated by the data separating device by using the program preview property information, and records the extracted program preview content on a recording medium as the content checking support data. Meanwhile, the digest saving/managing device relates the content checking support data that is recorded in the recording medium to the program preview property information/original program property information extracted by the metadata extracting device, and saves and manages those as the digest.

That is, prior to the actual broadcast of the original program, the original program property information is obtained along with the program preview property information from the program preview that is broadcasted in a timely manner. Then, the program preview content (the program preview video data or the program preview audio data, or the both) is obtained from the broadcasting signal, and it is recorded on a recording medium as the content checking support data. At the same time, a digest is created by relating the recording position of the content checking support data in the recording medium to the program preview property information/original program property information. Through this, the content checking support data and the original program that is planned to be broadcasted are related prior to the broadcast of the original program. A series of the above-described processing can be executed automatically even though the user pays no specific attention, so that the burden of executing program searching operation imposed upon the user can be lightened. Further, automatic accumulation of the content checking support data is performed limitedly on the program previews regarding the original program. Therefore, compared to the conventional technique, the required capacity of the recording medium and the consumed power can be decreased.

(2) The audio-visual content selecting circuit of the present invention with the structure described in (1) further comprises: a digest program editing device which selects a single or two or more digests that are necessary from at least a single digest that is saved/managed in the digest saving/managing device, and generates a digest program and information regarding the digest program from the selected digest;

an interface provided between the recording medium for recording the content checking support data and the audio-visual content selecting circuit;

a digest program reproduction request device for making a reproduction request of the digest program;

a digest program reproduction control device which performs control over the processing of reading out and reproducing content checking support data regarding the digest program from the recording medium via the interface according to the reproduction request, based on the information regarding the digest program in the digest program editing device;

a decoder for decoding the content checking support data regarding the digest program that is read out from the recording medium; and

an output device for outputting, to outside, the content checking support data that was decoded.

The audio-visual content selecting apparatus of the present invention corresponding to the audio-visual content selecting circuit with the above described structure, as described in (1), further comprises:

a digest program editing device which selects, from digests, a single or two or more digests, and generates a selected digest program and information regarding the digest program;

a digest program reproduction request device for making a reproduction request of the digest program;

a digest program reproduction control device which performs control on the processing of reading out and reproducing content checking support data regarding the digest program from the recording medium according to the reproduction request, based on the information regarding the digest program in the digest program editing device; and

a decoder for decoding the content checking support data regarding the digest program that is read out from the recording medium.

The digest program editing device selects a desired digest from the digest group that is managed in the digest saving/managing device to create a digest program. It is assumed here that the viewing history information of the viewer, information on the preference of the viewer, a keyword given by the viewer, and the like are used as the selection criteria of the desired digest. When there is a reproduction request from the digest program reproduction request device after completing the preparation described above, the digest program reproduction control device reads out the content checking support data from the recording medium according to the digest program information. The contents checking support data is decoded in the decoder, and the result is outputted to an external output apparatus from the output device. When there are a plurality of digest programs, the digest program reproduction control device reads out the digest programs one by one in predetermined order from the recording medium, and automatically reproduces the content checking support data from the decoder by the output apparatus. As described, it is unnecessary to search the digest manually and the digest programs are presented automatically. Thus, the burden of executing program searching operation imposed upon the user can be lightened. By employing at least the video data as the content checking support data, the program contents can be intuitively checked in an easy way.

(3) In the above-described structure, a plurality of the recording media are provided, and

the interface (content checking support data transfer device) selects an arbitrary recording medium from the plurality of recording media, and transfers the content checking support data to the recording medium that was selected.

(4) Further, it is preferable that the audio-visual content selecting circuit and the audio-visual content selecting apparatus of the present invention with the structure described in (2) further comprise: a digest designating device which accepts an input from a user for designating an arbitrary digest, based on the content checking support data regarding the digest program that is being reproduced; and

a reservation managing device which manages a recording reservation or a viewing reservation by referring to the original program property information of a related program that corresponds to the digest that is designated in the digest designating device.

The user checks the digest programs to be reproduced at the output device successively. When recognizing a program desired to be reserved for recording or viewing, the user designates the program by the digest designating device. As a result, the reservation managing device executes reservation for recording or viewing the designated program. Reservation can be achieved by simply designating the program while reproducing the digest program, thereby allowing the user to execute reserving operation with a simple action based on an intuitive response.

In the above-described structure, there is such a form that the metadata extracting device extracts, from the metadata: a content managing data for managing property information of the content; a related program content managing number for managing the content that corresponds to the related program; and a broadcast channel, broadcast start time, and information specifying program end of the content that corresponds to the related program. The information is managed as the categories in the digest generated by the digest saving/managing device.

Further, in the above-described structure, there is such a form that, when judged that said content property information extracted by said metadata extracting device is a program preview, said program preview extracting device starts extraction of said program preview content at a point where the current time reaches the broadcast start time of said content corresponding thereto, and ends extraction of said program preview content at a point where it has filled a condition that is calculated from said information specifying program end of the corresponding content.

Whether the current broadcasting signal is the program preview or the original program is judged from the content property information. When judged that it is the program preview, the program preview extracting device starts to record the program preview content from the point where the time has reached the broadcast start time of the program preview that is contained in the program preview property information, and reecord the program preview content till the program preview broadcast end time that is calculated from the information specifying program end. The recorded program preview content becomes the content checking support data.

Furthermore, in the above-described structure, there is such a form that the digest saving/managing device comprises:

a program preview property information managing device which manages content property information, when it is judged that the content property information extracted by the metadata extracting device is a program preview;

an original program property information managing device which manages content property information, when it is judged that the content property information extracted by the metadata extracting device is an original program;

a program preview related program searching device which detects whether or not a related program content managing number of a program preview in the program preview property information managing device is consistent with an original program content managing number in the original program property information managing device; and

a digest property information managing device which, when the program preview related program searching device detects that the numbers are consistent, manages: a content managing number in the program preview property information managing device; a related program content managing number in the original program property information managing device; a broadcast channel, broadcast start time, and information specifying program end of a related original program; and a recording position of the content checking support data in the recording medium that corresponds to the content managing number.

When the program preview related program searching device detects that the related program content managing number contained in the program preview property information is consistent with the original program content managing number in the original program property information, the content managing number in the program preview property information managing device, the related program content managing number in the original program property information managing device, the broadcast channel, the broadcast start time, and the information specifying program end of the related original program are related to the recording position of the content checking support data in the recording medium that corresponds to the content managing number so as to create a digest.

Further, in the above-described structure, there is such a form that, when a part of or the entire program preview related program information of a digest that is already being managed in the digest saving/managing device is consistent with program preview related program information that is extracted anew by the program preview extracting device, the digest saving/managing device excludes the digest that is extracted anew from a saving/managing target. With this, it becomes possible to avoid creating the overlapping digests, thereby improving the processing efficiency and reducing the power consumption.

Furthermore, content recording support apparatus of the present invention comprises:

the audio-visual content selecting apparatus described in (1); and

a digest property information managing device which manages: a related program content managing number in the original program property information managing device; a broadcast channel, broadcast start time, and information specifying program end of a related original program; a content managing number in the program preview property information managing device; and a recording position of the content checking support data in the recording medium that corresponds to the content managing number.

Further, in the above-described structure, the content checking support data is at least either program preview video data or program preview audio data, or both.

Furthermore, in the above-described structure, there is such a form that: a plurality of the recording media are provided; and

the content checking support data transfer device selects an arbitrary recording medium from the plurality of recording media, and transfers the content checking support data to the recording medium that was selected.

Further, in the above-described structure, there is such a form that the recording media are connected within the same equipment via the content checking support data transfer device.

Moreover, in the above-described structure, there is such a form that the recording media are connected to external equipment via the content checking support data transfer device.

Further, in the above-described structure, there is such a form that the content checking support data transfer device selects the recording medium by referring to the program preview property information.

Furthermore, in the above-described structure, there is such a form that the content checking support data transfer device selects the recording medium to which the content checking support data is transferred by referring to reference data that is designated by a user separately, in addition to the program preview property information extracted by the metadata extracting device.

With the present invention, the original program property information is obtained, prior to the actual broadcast of the original program, along with the program preview property information from the program preview that is broadcasted in a timely manner. Then, the program preview content is obtained from the broadcasting signal, and it is recorded on a recording medium as the content checking support data. At the same time, a digest is created by relating the recording position of the content checking support data to the program preview property information/original program property information. Through this, the content checking support data and the original program that is planned to be broadcasted are related prior to the broadcast of the original program. This processing can be executed automatically even though the user pays no specific attention, so that the burden of executing program searching operation imposed upon the user can be lightened. It is not necessary to provide a mechanism for detecting highlight scenes from the original program or a mechanism for collecting only the extracted highlight scenes and putting them into a single content. Thus, it becomes possible to create a program content checking system with a still smaller number of structures.

Further, accumulation of the content checking support data is performed limitedly on the program previews regarding the original program. Therefore, compared to the conventional technique, the capacity of the recording medium and the power consumption can be decreased.

Further, it is unnecessary for the user to check (search) the digest manually, and the digest programs can be checked in a fully automatic manner. Thus, the burden of executing program searching operation imposed upon the user can be lightened. If the video data is at least contained in the content checking support data, the program contents can be intuitively checked in an easy way. It is still better if the audio data is contained therein as well.

Furthermore, reservation for recording or viewing a program can be achieved by simply designating the program while reproducing the digest program, thereby allowing the user to achieve reserving operation with a simple action based on an intuitive response.

The present invention enables a receiving terminal of the broadcast content that is transmitted on the broadcasting waves or the like to obtain the video/audio information showing the original program content as the content checking support data, prior to the broadcast start time. The present invention therefore is useful as a system for supporting the viewers in the program searching operation, and in reserving operation to view and record video/sound of the program. The video/audio information mentioned above may be audio information alone.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram for showing the structure of an audio-visual content selecting apparatus according to a first embodiment of the present invention;

FIG. 2 shows the data structure of metadata according to the first embodiment of the present invention;

FIG. 3 is a flowchart of the metadata processing executed by a metadata extracting device according to the first embodiment of the present invention;

FIG. 4 shows an illustration of the data structure of program preview property information that is managed by a program preview property information managing device according to the first embodiment of the present invention;

FIG. 5 shows an illustration of the data structure of original program property information that is managed by an original program property information managing device according to the first embodiment of the present invention;

FIG. 6 shows an illustration of the data structure of digest property information that is managed by a digest property information managing device according to the first embodiment of the present invention;

FIG. 7 is a block diagram for showing the structure of an audio-visual content selecting apparatus (with a digest presenting function) according to a second embodiment of the present invention;

FIG. 8 shows an illustration of the data structure regarding a digest property information table and a digest presenting list according to the second embodiment of the present invention;

FIG. 9 is a flowchart for showing procedures of processing executed by a digest reproduction control device according to the second embodiment of the present invention;

FIG. 10 is a block diagram for showing the structure of an audio-visual content selecting apparatus (with a recording/ viewing reservation function) according to a third embodiment of the present invention;

FIG. 11 is a flowchart for showing procedures of recording/viewing reservation processing according to the third embodiment of the present invention;

FIG. 12 is a block diagram for showing the structure of an audio-visual content selecting apparatus according to a fourth embodiment of the present invention;

FIG. 13A-FIG. 13D are block diagrams for showing connection examples (the first examples) of recording media according the fourth embodiment of the present invention;

FIG. 14A-FIG. 14D are block diagrams for showing connection examples (the second examples) of recording media according to the fourth embodiment of the present invention;

FIG. 15 shows an illustration of the data structure of a recording medium managing table according to the fourth embodiment of the present invention;

FIG. 16 shows an illustration of the data structure of a digest managing table according to the fourth embodiment of the present invention;

FIG. 17 shows an illustration of the data structure where the digest managing table according to the fourth embodiment of the present invention shown in FIG. 16 is being divided;

FIG. 18 is a flowchart of the procedure according to the fourth embodiment of the present invention, which determines a transfer destination recording medium of the program preview and records the program preview thereon;

FIG. 19 is an illustration for describing an example of data updates made when transferring/recording a program preview to a plurality of recording media according to the fourth embodiment of the present invention;

FIG. 20A-FIG. 20D are illustrations for describing examples of data generation performed when creating a digest program from the program previews recorded on the plurality of recording media according to the fourth embodiment of the present invention;

FIG. 21 is an illustration of the data structure regarding a transfer destination selection table according to the fourth embodiment of the present invention;

FIG. 22 is a first flowchart for showing the procedure according to the fourth embodiment of the present invention, which determines a transfer destination recording medium of the program preview by utilizing categories of a large classified group of the program preview property information and records the program preview thereon;

FIG. 23 is a second flowchart for showing the procedure according to the fourth embodiment of the present invention, which determines a transfer destination recording medium of the program preview by utilizing categories of a large classified group of the program preview property information and records the program preview thereon;

FIG. 24 is a flowchart of the procedure according to the fourth embodiment of the present invention, when recording a program preview on a recording medium designated by a user;

FIG. 25 is a first flowchart for showing the procedure according to the fourth embodiment of the present invention, which judges a transfer destination recording medium according to a keyword that is designated by the user and records the program preview thereon;

FIG. 26 is a second flowchart for showing the procedure according to the fourth embodiment of the present invention, which judges a transfer destination recording medium according to a keyword that is designated by the user and records the program preview thereon; and

FIG. 27 is an illustration of a time table depicted in Patent Literature 1.

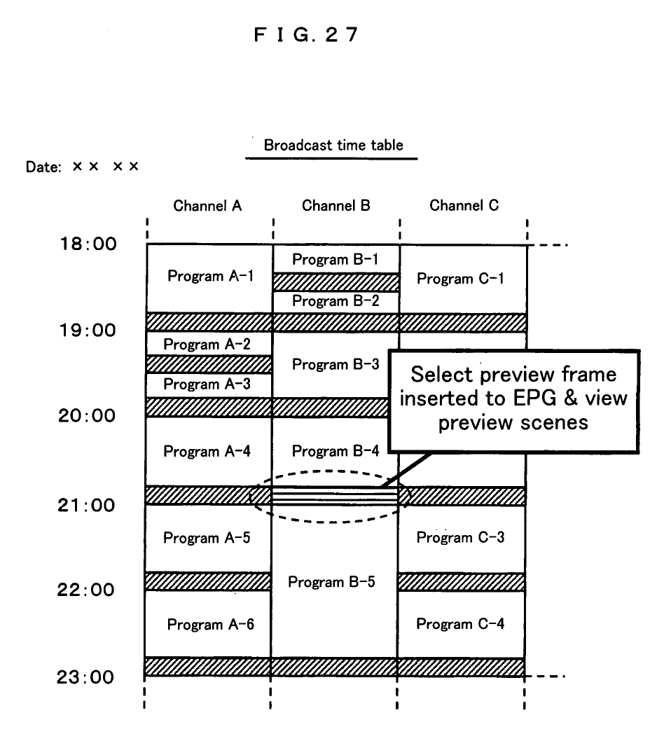

### DETAILED DESCRIPTION OF THE INVENTION

An audio-visual content selecting apparatus according to the respective embodiments of the present invention will be described hereinafter by referring to the accompanying drawings.

### First Embodiment

A first embodiment of the present invention is a technique which captures, prior to the actual broadcast of an original program, a program preview content (program preview video data/program preview audio data) which is being broadcasted in a timely manner as content checking support data, and relating it to the information of the original program that corresponds to the program preview mentioned above. A digest containing the related data is used as a guide for searching or checking original programs that are planned to be broadcasted in the future.

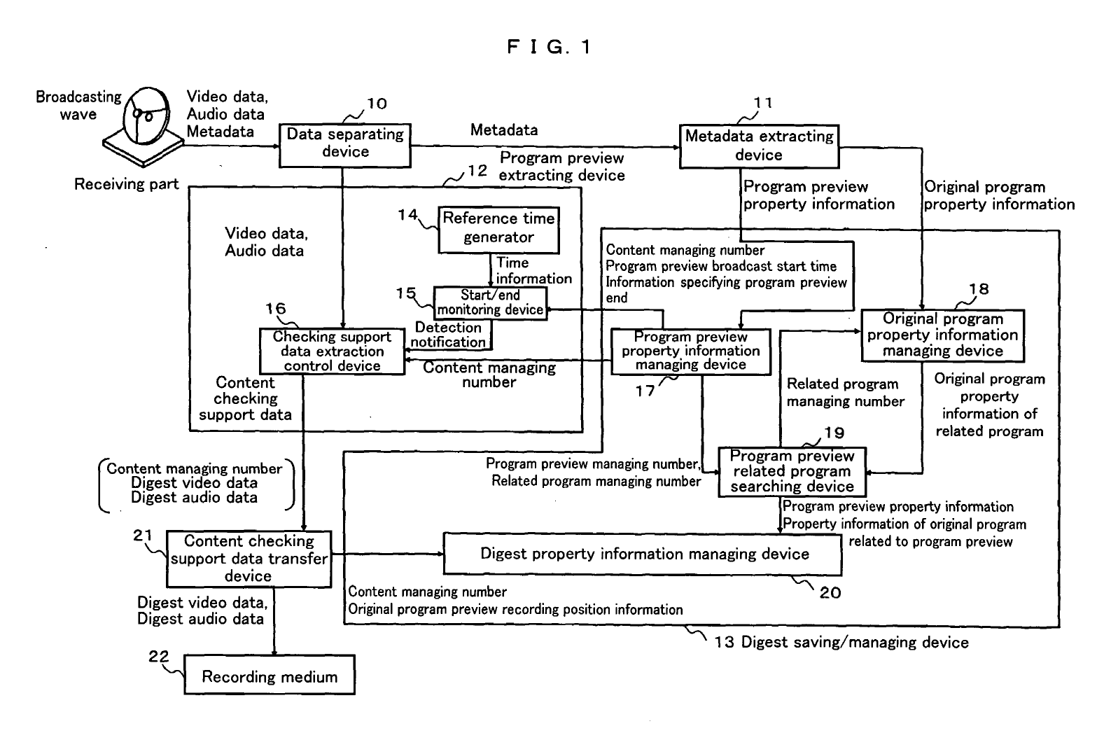

FIG. 1 is a block diagram for showing the structure of the audio-visual content selecting apparatus according to the first embodiment of the present invention. In FIG. 1, reference numeral 10 is a data separating device for separating a multiplexed broadcasting signal into video data, audio data, and metadata (description of the structural information of the contents and other additional information) which shows the program contents. Reference numeral 11 is a metadata extracting device which extracts, from the metadata thus separated, the program preview property information and the original program property information as the property information necessary for editing the contents. Reference numeral 12 is a program preview extracting device which extracts, as the content checking support data, the video data and the audio data that corresponds to the program preview, when the property information extracted by the metadata extracting device 11 is the program preview property information. Reference numeral 13 is a digest saving/managing device which brings the property information (the program preview property information/the original program property information) extracted by the metadata extracting device 11 in correspondence with the recording position of the content checking support data (program preview contents (audio/video data)) extracted by the program preview extracting device 12 and saves and manages the results as a digest.

The program preview extracting device 12 comprises a reference time generator 14, a start/end monitoring device 15, and a checking support data extraction control device 16. The reference time generator 14 generates the reference time which is used within the audio-visual selecting apparatus. The start/end monitoring device 15 notifies the reference time that is generated by the reference time generator 14, and notifies that it has reached a set time. The set time includes the broadcast start time and the broadcast end time, and the broadcast end time is calculated from information specifying program end. The checking support data extraction control device 16 transfers the content checking support data to a content checking support data transfer device 21. The content checking support data includes the video data and the audio data of the program preview. The content checking support data transfer device 21 executes control on the processing of extracting the content checking support data from the video data and the audio data being separated from the broadcast wave by the data separating device 10, and transferring it to a recording medium 22.

Processing for notifying the broadcast start time and the information specifying program end to the start/end monitoring device 15 is performed by a program preview property information managing device 17 provided in the digest saving/managing device 13 that is described later. Control executed by the checking support data extraction control device 16 include checking support data recording/editing control.

The digest saving/managing device 13 comprises the program preview property information managing device 17, an original program property information managing device 18, a program preview related program searching device 19, and a digest property information managing device 20.

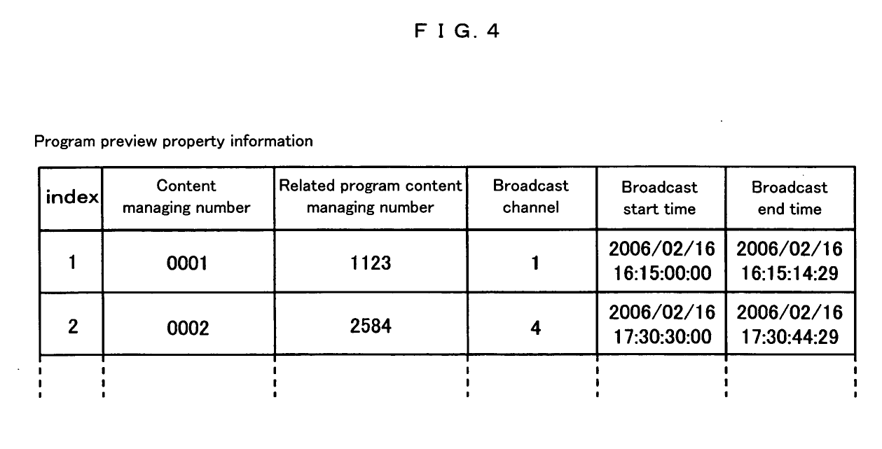

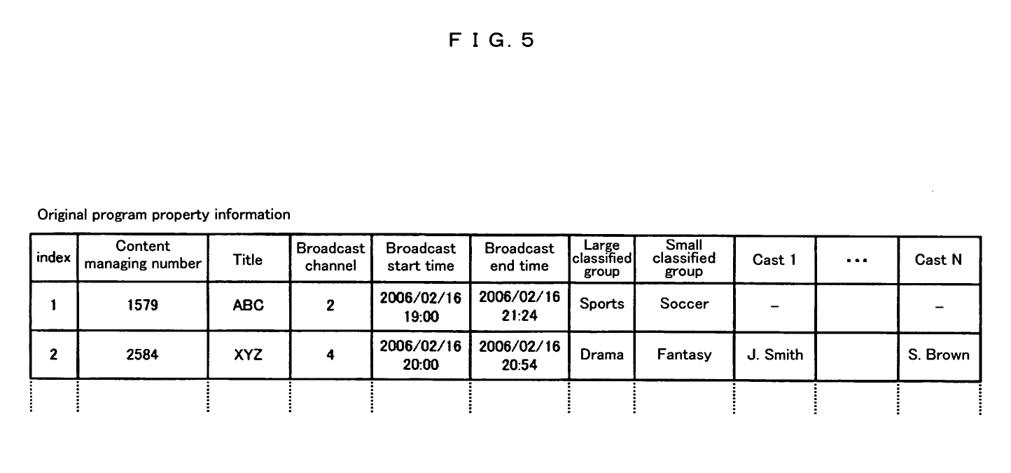

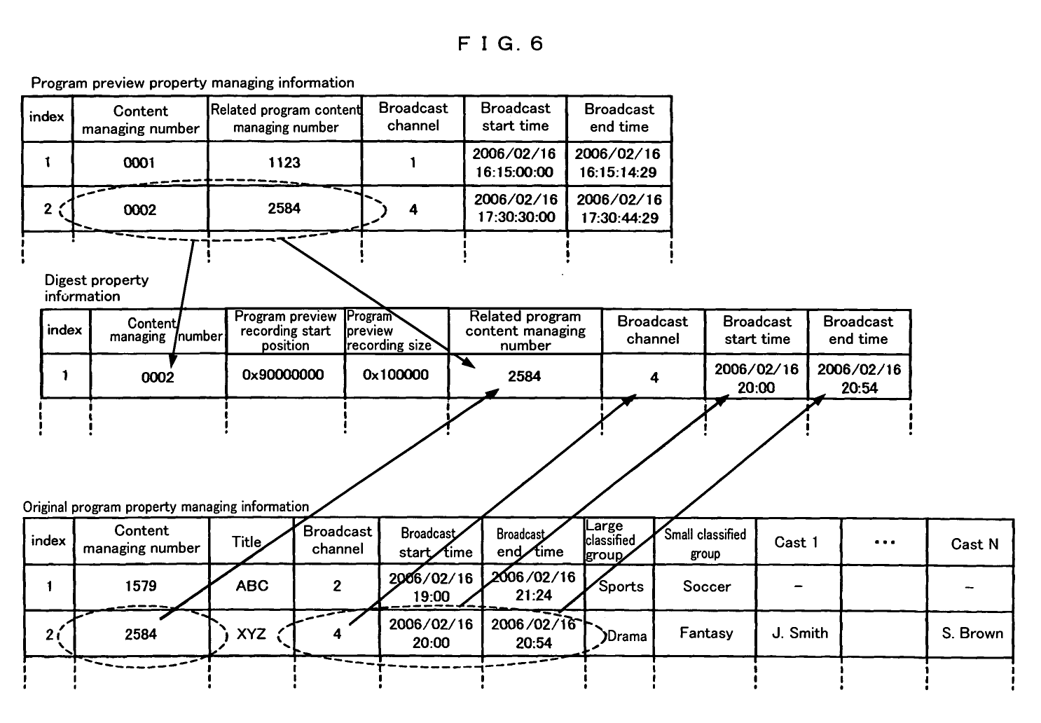

The program preview property information managing device 17 saves and manages the metadata (for example, a content managing number, a related program content managing number, a broadcast channel, a program preview broadcast start time, a program preview broadcast end time, and the like: see FIG. 4 and FIG. 6) of the program preview, which contains the related program information extracted by the metadata extracting device 11. The original program property information managing device 18 saves and manages the metadata (for example, a content managing number, a broadcast channel, a broadcast start time, a broadcast end time: see FIG. 5 and FIG. 6) of the original program, which is extracted by the metadata extracting device 11. The program preview related program searching device 19 judges whether or not the related program content managing number in a record saved in the program preview property information managing device 17 is consistent with the content managing number in a record saved in the original program property information managing device 18.

The digest property information managing device 20 brings the recording position of the content checking support data in the recording medium 22 in correspondence with the program preview related program information and saves and manages the result as a digest. This saving processing is performed upon receiving a notification from the program preview related program searching device 19 that the managing numbers are consistent. The recording position of the content checking support data is an address, for example, which is extracted by the program preview extracting device 12 and determined by the content checking support data transfer device 21. The program preview related program information includes a content managing number, a related program content managing number, a broadcast channel, an original program broadcast start time, an original program broadcast end time, and the recording position of the content checking support data, for example. Those are managed by the program preview property information managing device 17 and the original program property information managing device 18. The program preview related program information can be referred in FIG. 6.

The media for supplying the multiplexed signals to be inputted to the data separating device 10 are all types of broadcasting, but the main type thereof is digital broadcasting. Further, although the main communication media are terrestrial broadcasting and satellite broadcasting, cable broadcasting (CATV) and broadcasting using telephone circuits may also be considered.

Furthermore, the broadcasting signals may be the kinds to which viewing restriction such as scrambling is applied. In such cases, separation of the video data, the audio data, and the metadata is performed in the data separation processing of the data separating device 10, for example, after the processing for lifting the viewing restriction of the broadcasting signal. As another example, the broadcasting signals to which the viewing restriction is still applied are accumulated, and the viewing restriction is lifted at the time or reproduction on a decoder side.

Further, the information specifying program end is the information that can specify the end of the program, typically represented by the program end time information, the information indicating the length of the broadcast time of the program, change point information of an ID that specifies the program, which is contained in the broadcast wave, etc.

Furthermore, although the main recording medium is a hard disk, other recording media such as a memory card and an optical disk may also be considered.

Moreover, the recording position of the above-described content checking support data may be of any sorts as long as the recording region on the recording medium can be identified uniquely. For example, it may be the information such as a track number or a sector number.

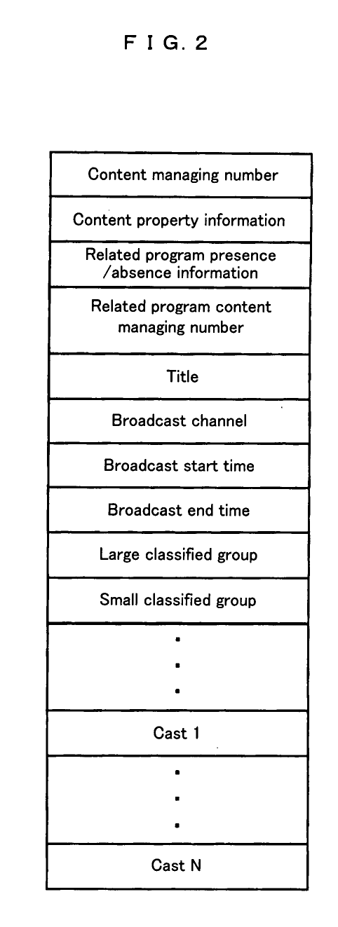

FIG. 2 shows an example of the data structure of the metadata that is separated by the data separating device 10 and inputted to the metadata extracting device 11. The data structure has: a content managing number that is given at the time of transmission for uniquely specifying the program preview content or the original program content; content property information for judging whether the content is the program preview or the original program; related program presence/absence information for judging whether the program that is related to the content is present or absent, when the content is a program preview; a related program content managing number which designates the content managing number of the related program, when there exits a program related to the content; and the broadcast channel information, the broadcast start time, and the broadcast end time of the content. The metadata may also contain additional information regarding the content, such as title information given to the content, classification information showing the details of the content (for example, genre information such as “sport” and “drama”), parental level information, and information on the casts that appear on the content.

The broadcast channel information may be of any sorts as long as it makes it possible to identify station selection uniquely, and the information used therefor may be constituted with a plurality of pieces. An example thereof may be a method which specifies a broadcast channel by referring to a plurality of pieces of information contained in the broadcast wave such as network information, frequency information, and the like and combining the results of reference.

Now, the operation of the audio-visual content selecting apparatus of the present embodiment constituted in the above-described manner will be described. Video data, audio data, and metadata showing the program content are superimposed on the broadcasting signal that is received by a receiving antenna. The data separating device 10 separates the video data, the audio data and metadata showing the program content from the multiplexed broadcasting signal, then sends out the video data and the audio data to the checking support data extracting device 16 of the program preview extracting device 12, while sending out the metadata to the metadata extracting device 11. The metadata extracting device 11 extracts, from the metadata, the program preview property information and the original program property information as the property information necessary for editing the contents. Then, the metadata extracting device 11 sends out the program preview property information to the program preview property information managing device 17, and sends out the original program property information to the original program property information managing device 18.

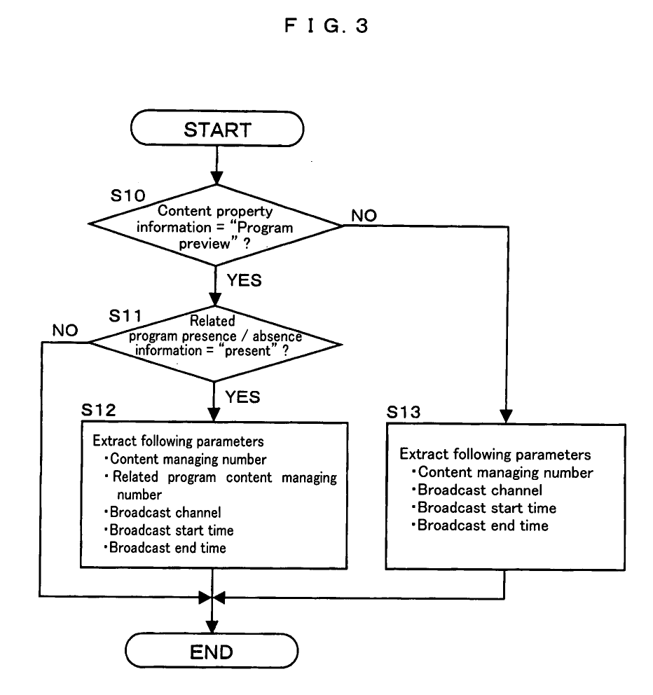

FIG. 3 is a flowchart showing an example of procedures of the metadata extraction processing executed by the metadata extracting device 11. When the metadata is inputted, the metadata extracting device 11 reads the content property information from the metadata, and judges whether the content is the program preview or the original program in step S10.

When judged in the step S10 that the content is the program preview, the metadata extracting device 11 reads the related program presence/absence information from the metadata, and judges whether or not the content holds the information regarding the related program in step S11.

When judged in the step S11 that there exists a related program, it means that the metadata is the program preview and there exists the related program. In this case, the content managing number, the related program content managing number, the broadcast channel, the broadcast start time, and the broadcast end time are read from the metadata in step S12. When judged in the step S11 that there is no related program, the processing is ended without saving the metadata.

When judged in the step S10 that the content is not the program preview, the metadata extracting device 11 judges that the content shown by the metadata is an original program. Thus, it reads the content managing number, the broadcast channel, the broadcast start time, and the broadcast end time from the metadata in step S13.

In the flowchart of FIG. 3, the description is made on assumption that metadata other than those for the program preview and the original program is excluded in advance from the target of the processing. Examples of the metadata exclude from the target include those for product CMs, and public service advertisements.

The program preview property information managing device 17 that has received the program preview property information from the metadata extracting device 11 manages the content managing number that specifies the program preview content, the broadcast channel that is required for obtaining the video and audio information of the program preview, the broadcast start time, the broadcast end time, and the related program content managing number that is related to the program preview. FIG. 4 shows an example of the format of the metadata that is managed by the program preview property information managing device 17.

The program preview property information managing device 17 gives the broadcast start time and the broadcast end time of the program preview to the start/end monitoring device 15 of the program preview extracting device in a timely manner, while giving the content managing number to the checking support data extraction control device 16.

The original program property information managing device 18 that has received the original program property information from the metadata extracting device 11 puts into a single record the content managing number, the broadcast channel, the broadcast start time, and the broadcast end time of the metadata that is judged as having the information of the original program, and manages each record by giving an index thereto so that each record can be specified uniquely. FIG. 5 shows an example of the metadata format that is managed by the original program property information managing device 18.

The start/end monitoring device 15 in the program preview extracting device 12 sets the broadcast start time received from the program preview property information managing device 17 as a comparison criterion, and monitors whether or not the current time has reached the broadcast start time that is set in the reference time supplied from the reference time generator 14. When the current time has reached the broadcast start time in the reference time, the start/end monitoring device 15 informs so to the checking support data extraction control device 16. Upon receiving the notification, the checking support data extraction control device 16 starts the processing for recording, on the recording medium 22, the video data and the audio data from the data separating device 10 as the content checking support data, regarding the broadcasting signal that corresponds to the content managing number received from the program preview property information managing device 17. For the calculation of the recording position (for example, address) of the content checking support data in the recording medium 22, it is determined in advance in the content checking support data transfer device 21. After the start/end monitoring device 15 informs the checking support data extraction control device 16 that the current time has reached the broadcast start time, the information specifying program end is set by the program preview property information managing device 17. When it fills the condition calculated from the information specifying program end, the checking support data extraction control device 16 ends the extraction and recording of the content checking support data. The content checking support data transfer device 21 informs the content managing number and the recording position of the content checking support data recorded in the recording medium 22 to the digest property information managing device 20. Accumulation of the above-described content checking support data on the recording medium 22 is performed prior to the broadcast of the original program.

The checking support data extraction control device 16 performs extraction and recording of the content checking support data only when the property information extracted by the metadata extracting device 11 is the program preview property information. Therefore, compared to the conventional technique where recording is continued without discriminating between the original program and the program preview, the load of the processing under a steady state and the required capacity of the recording medium can be decreased in the present embodiment where the recording of the program is limited to the program preview. In addition, extraction and recording of the content checking support data is not performed at the time of broadcasting the original program, so that deterioration of the processing efficiency can be reduced.

Meanwhile, the program preview related program searching device 19 in the digest saving/managing device 13 reads the related program content managing number in a record saved in the program preview property information managing device 17, and searches the record that matches with the content managing number saved on the original program property information managing device 18. When detecting a matching record, the program preview related program searching device 19 informs it to the digest property information managing device 20. Search of the related program content managing number is performed, for example, according to the order of the indexes given to each record of the original program property information managing device 18. However, it may be executed in any other ways.

The digest property information managing device 20 performs the following processing, upon receiving a notification from the program preview related program searching device 19 that the related program content managing number of the program review is consistent with the original program content managing number. In this case, the digest property information managing device 20 reads the content managing number of the program preview from the program preview property information managing device 17, and reads the related program content managing number of the program preview, broadcast channel of the related original program, the broadcast start time of the related original program, and the broadcast end time of the related original program from the original program property information managing device 18. Further, the digest property information managing device 20 reads the recording position and recording size information of each data from the content checking support data transfer device 21. Each data herein means the content managing number, the digest video data, and the digest audio data. FIG. 6 shows an example of the formats of each data, and a correlation among each data.

In FIG. 6, there is described the case of using the recording position and the recorded size information of the content checking support data. However, it is also possible to use other information that is capable of uniquely specifying the stored position on the recording medium, e.g., the recording start position information, the recording end position information. In FIG. 6, the digest property information is described in a form of a single table. However, it may be constituted with a plurality of tables.

As a result of the above, the video/audio data of the program preview including the property information of the related program is accumulated in advance on the recording medium 22 as the content checking support data. At the same time, the digest that is linked to the recording position of the content checking support data in that accumulation can be saved and managed.

Regarding the styles for managing the metadata in this embodiment, the program preview property information managing device 17, the original program property information managing device 18, and the digest property information managing device 20 all employ the table style. However, any other styles may be employed.

Further, although the digest property information managing device 20 obtains the content managing number from the content checking support data transfer device 21, it is also possible to record the content managing number in the recording medium 22, and then obtain the content managing number through the digest property information managing device 20 via the recording medium 22.

The above-described explanations are provided assuming the case of the digital broadcasting. Instead, there is also considered a method which generates a digest from the analog broadcasting, and transfers it to the digest saving/managing device 13. For example, the border at which the broadcast of the original program and that of the program preview are switched is monitored by the program preview extracting device 12 at a previous stage of the checking support data extracting device 16 through detecting whether or not stereo and monaural modes of the audio are switched. Then, the program preview video/audio data is recorded on the recording medium 22 as the content checking support data at intervals of fifteen seconds (CM broadcast time) right after the occurrence of the switching. Alternatively, textual information is extracted from the program preview video data to create metadata.

It is also possible to obtain the metadata in the following manner. That is, it is quite likely that the textual information and the like indicating the details of the content such as a title is displayed in a period where there is less move between the frames in the program preview video data. Thus, image data of one frame is cut out from the program preview video data within that period, and the textual information included in the cutout image data is extracted as the metadata through the image analysis.

Further, the extracted textual information is collated with an original database or information on the Internet via a communication medium, and the information relevant to the textual information is extracted as the metadata.

With each of the methods described above, it is possible to relate the program preview to the original program information without using the metadata that is multiplexed on the digital broadcasting wave. For the method of extracting the program preview video data, program preview audio data, and the metadata from the analog broadcasting, other methods may also be used.

Furthermore, the constitution is such that double management is avoided when a digest that is the same as the already-recorded digest is detected. A method of detecting whether a digest is the same as the already-recorded digest is performed as follows, for example. The overlapping of digests is checked by finding out whether or not the content managing number of the program preview that is contained in the program preview property information extracted by the metadata extracting device 11 is consistent with the content managing number of the digest property information that is saved/managed in the digest saving/managing device 13. Alternatively, the above-described judgment on the overlapping of digests may be performed by using information other than the content managing number. Further, a method of avoiding double management is performed as follows, for example. That is, double management is avoided by discarding the newly extracted program preview video/audio data and the digest property information that is newly generated from the metadata.

The judgment on the overlapping of digests can be performed either at the point before recording the program preview video/audio data on the recording medium 22 or at the point after the recording. When it is performed before recording the program preview video/audio data on the recording medium 22 in particular, the video/audio data of the same program preview that is repeatedly broadcasted is not recorded on the recording medium 22. Thus, the required capacity of the recording medium 22 can be reduced.

As described above, with the present embodiment, the content checking support data that is useful for checking the original program contents is extracted from the program preview video/audio data. Thus, it requires no mechanism for detecting a highlight scene from the original program or a mechanism for collecting only the extracted highlight scenes and putting those into a single content. Therefore, it is possible to create a program content checking system through moving pictures with a still smaller number of components. Further, by utilizing the program preview provided by broadcasting business providers as it is, it becomes possible to secure more chances to present the program preview to the viewers.

### Second Embodiment

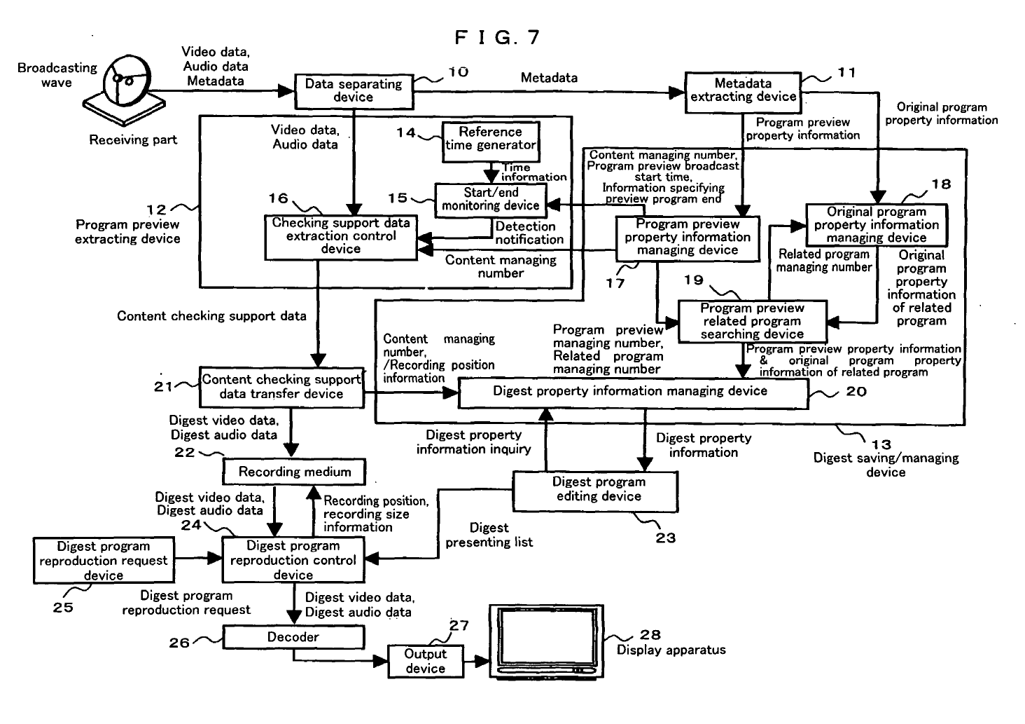

A second embodiment of the present invention is a technique for presenting the content checking support data regarding the original program contents to the viewers in a form of moving pictures before the broadcast time. FIG. 7 is a block diagram for showing the structure of an audio-visual content selecting apparatus according to the second embodiment of the present invention. In FIG. 7, the same reference numerals as those of FIG. 1 according to the first embodiment indicate the same structural elements. The peculiar structures of this embodiment are as follows. In FIG. 7, reference numeral 23 is a digest program editing device which selects, in accordance with a prescribed condition, a plurality of digests from the digests that are saved and managed in the digest property information managing device 20 of the digest saving/managing device 13, and connects those to create a program. Reference numeral 24 is a digest program reproduction control device which reads out the corresponding program preview video data/program preview audio data from the recording medium 22 in the registered order with the digest program that is generated by the digest program editing device 23, and transfers the readout data to a decoder 26 that is described later. Reference numeral 25 is a digest program reproduction request device which transmits a request to the digest program reproduction control device 24 to start reproduction of the digest program. Reference numeral 26 is a decoder for decoding the content checking support data that is read out from the recording medium 22 via the digest program reproduction control device 24. Reference numeral 27 is an output device which outputs the content checking support data that has been decoded in the decoder 26 to a display device 28 that is connected to the outside. The digest program reproduction request device 25 is constituted with a button used exclusively for transmitting a request, or a button used also for other functions. Those buttons may be provided to a terminal that is capable of achieving remote control, such as a remote controller. Other structures are the same as those of the first embodiment, thus explanations thereof are omitted.

Now, the operation of the audio-visual content selecting apparatus of the embodiment constituted as described above will be described. The digest program editing device 23 reads the digest property information that is saved in the digest property information managing device 20, and determines the order in which the content checking support data is presented to the viewer when reproducing the digest program. As the criterion for selecting the digests to be included in the digest program, used are the viewing history record of the viewer, preference information of the viewer, a keyword supplied by the viewer from outside, information on the viewing tendency of the viewer, and the like. Further, time information may be used as the selecting criterion, and the selection probability may be increased for the original program whose broadcast start time is closer to the current time. Alternatively, the digest of the original program whose broadcast end time has already passed before the current time may be excluded from the digest program.

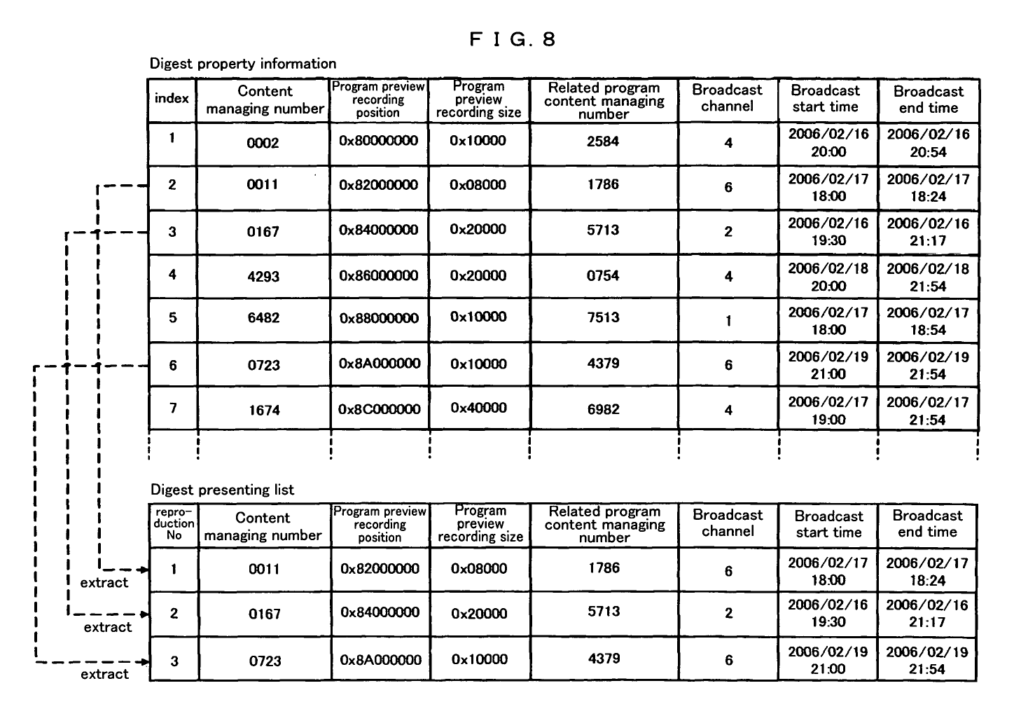

The information on the presenting order of the content checking support data determined in the digest program editing device 23 is saved in a form of a digest presenting list. FIG. 8 shows an example of the digest presenting list. Registration of the digests with the digest presenting list is performed by copying the information in each record of the digest property information table that is extracted from the digest property information managing device 20, and by changing the indexes that are given in the digest property information table with the numbers in the reproduction order No. Registration of the digests with the digest presenting list is performed by repeating the step of copying the information in each record of the digest property information table and the step of changing the index with the reproduction order No.

The number of the digests included in the digest presenting list may be determined by referring to the upper limit value of the the number of digests, or may be determined on the basis of information such as the entire viewing time when all the digests are put into a program. The digest reproduction order information is managed in a table style. However, other styles may be employed.

The digest program reproduction control device 24 judges the recording positions and the recorded sizes of the content checking support data from the digest presenting list generated by the digest program editing device 23. Then, the digest program reproduction control device 24 performs control on the processing of reading out the corresponding content checking support data from the recording medium 22, and transferring it to the decoder 26.

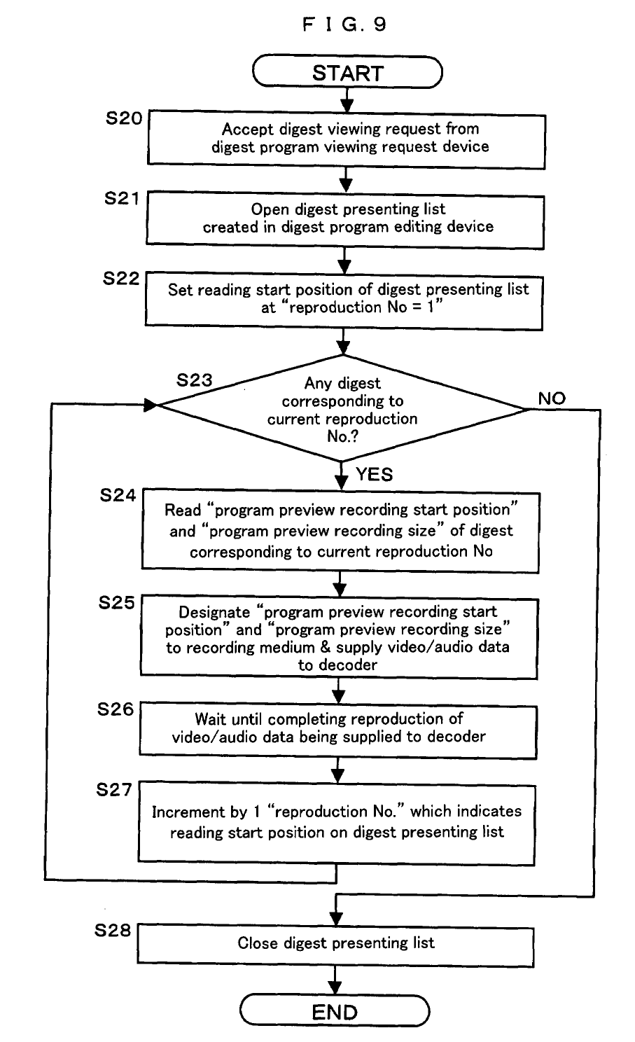

An example of the procedures of the digest program reproduction processing performed by the digest program reproduction control device 24 will be described by referring to FIG. 9. Upon receiving a digest reproduction request from the digest program reproduction request device 25 in step S20, the digest program reproduction control device 24 performs processing in step S21 to open the digest presenting list that is generated by the digest program editing device 23 and then, in step S22, sets a pointer showing the reading start position on the digest presenting list at “reproduction No=1” to complete the initialization processing of the digest program reproduction control device 24. Thereafter, in step S23, it is judged whether or not there is a digest that corresponds to the current reproduction No. When there exists a digest that corresponds to the current reproduction No., the “program preview recording start position” and the “program preview recording size” of the digest that corresponds to the current reproduction No. is read in step S24. Then, in step S25, the “recording start position” and “recording size” are designated to the recording medium 22 to read out the corresponding program preview video data/program preview audio data, and the processing is started to output the readout data to the display device 28 via the decoder 26 and the output device 27. In step S26, it is detected that the output of the content checking support data that is started in the step S25 is completed. In step S27, the reproduction No. indicating the reading start position of the digest presenting list is incremented by 1 as a preparation for starting the reproduction of the content checking support data of the next digest registered in the digest presenting list. A series of the processing from the step S24 to the step S27 is executed as long as it is judged that there exists a digest that corresponds to the current reproduction No. When judged in the step S23 that there is no digest that corresponds to the current reproduction No., closing processing of the digest presenting list is performed in step S28 to end the reproduction processing of the digest program. For the order of presenting the digests, it is possible to employ other methods such as presenting the digests by randomly selecting those from the digest presenting order list.

With this embodiment, the viewer can check the program contents intuitively before the broadcast of the original program through the moving-picture display of the content checking support data. Further, the content checking support data is automatically presented in order, so that it becomes unnecessary for the viewer to do searching operation manually even if there are a large number of channels and a large number of program previews. Therefore, the burden of operating the equipment imposed on the viewer can be lightened.

Further, the digest presenting order list generated by the digest program editing device 23 can be used as it is as the viewing history information of the program preview, showing which program previews the viewer has viewed. By transferring the viewing history information of the program previews to an external tabulation device by using communication devices such as the Internet, or a telephone circuit, it is possible for sponsors to create a program rating tabulation system for checking the effects such as the reputation of the program preview for each of the program previews, or to create a data tabulation system for collecting and totalizing the preference information of the individual viewers.

### Third Embodiment

A third embodiment of the present invention is a technique which allows the viewer to intuitively check the program contents through the digest program, and then to perform recording or viewing reservation according to a request of the viewer from the digest program.

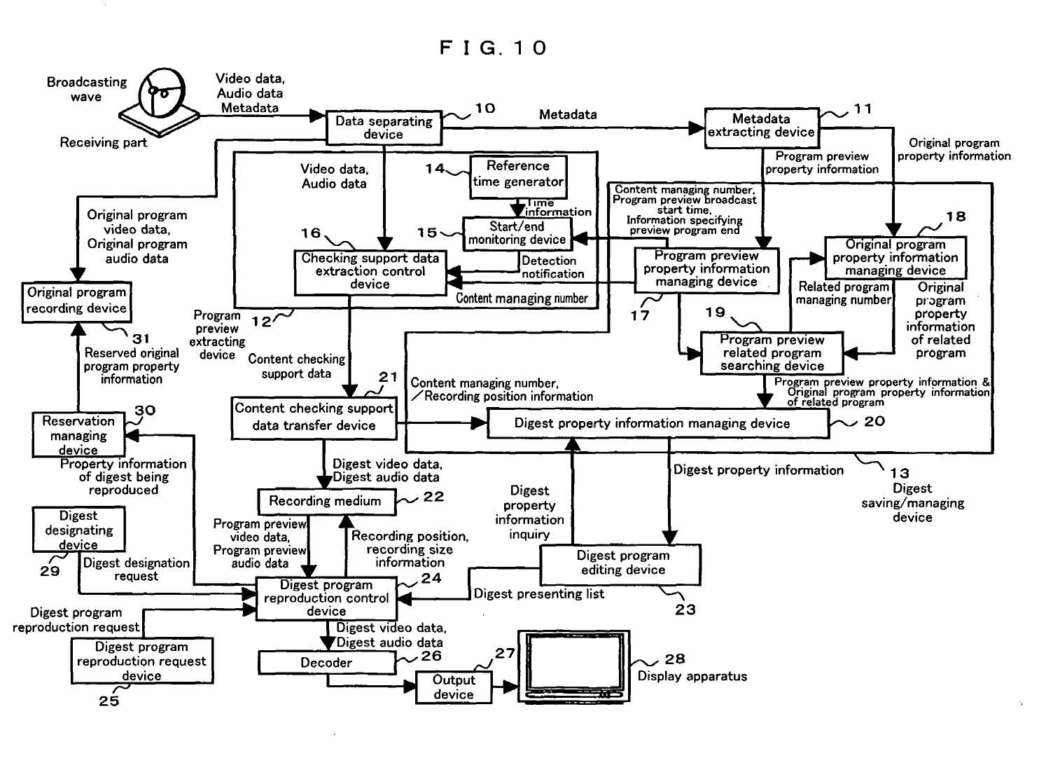

FIG. 10 is a block diagram for showing the structure of an audio-visual content selecting apparatus according to a third embodiment of the present invention. In FIG. 10, the same reference numerals as those of FIG. 7 according to the second embodiment indicate the same structural elements. The peculiar structures of this embodiment are as follows. In FIG. 10, reference numeral 29 is a digest designating device for designating the currently reproducing digest for recording or viewing reservation. Reference numeral 30 is a reservation managing device which registers and manages recording/viewing reservation of the related program that is related to the currently presented digest. Reference numeral 31 is an original program recording device for recording the video data and the audio data separated by the data separating device 10 as the original program by using the broadcast channel, the broadcast start time, and the broadcast end time of the original program property information that is managed in the reservation managing device 30.

The structure of the original program recording device 31 is the same as an existing recording system using the recording medium such as an HDD (hard disk) or a DVD, thus an explanation thereof is omitted. Further, the digest designating device 29 may be provided with separate reservation-only buttons so that it becomes possible to judge whether the reservation is a recording reservation or a viewing reservation. It is also possible to provide a button for transmitting recording/viewing reservation request to the digest program reproduction request device 25.

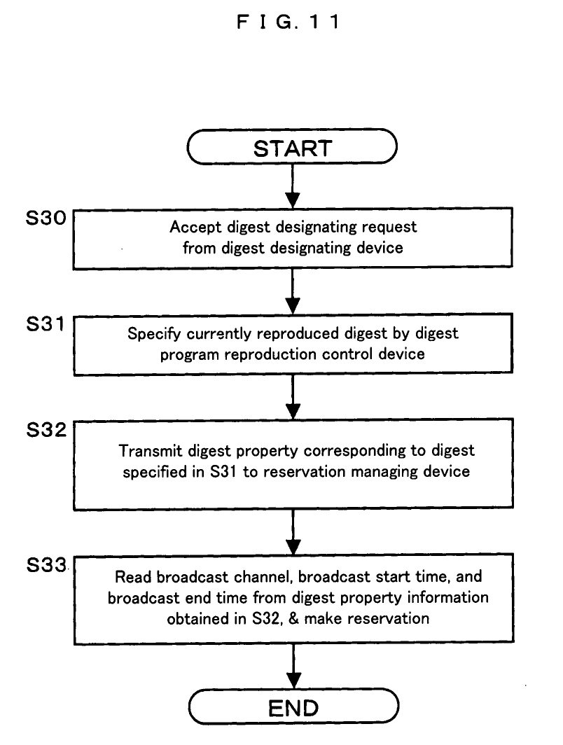

Next, the operation of the audio-visual content selecting apparatus according to the present embodiment constituted as described above will be described. FIG. 11 shows the procedures of processing for recording/viewing reservation performed by using the digest designating device 29 and the reservation managing device 30. The recording/viewing reservation processing using the digest program is started upon receiving a request from the digest designating device 29 during the reproduction of the digest program.

In step S30, designation of the digest program from the digest designating device 29 is transmitted to the digest program reproduction control device 24. In step S31, a digest which is being produced when a request is made in the step S30 is specified. In step S32, the property information of the digest specified in the step S31 is read out, and transmitted to the reservation managing device 30. In step S33, information on the broadcast channel, the broadcast start time, and the broadcast end time are extracted from the digest property information that has been transmitted in the step S32, and the extracted information is registered in the reservation managing device 30. Between the steps shown in FIG. 11, a step of displaying a message for checking the reservation operation of the viewer may be added.

With the embodiment, it is possible to perform a reservation operation by utilizing the content checking support data through relating the content checking support data (program preview video data/audio data) to the property information of the related program in advance. Further, reservation can be completed by a single step of selecting a moving picture the viewer is watching. Therefore, compared to a reservation system using EPG or the like, it is possible to complete the reservation operation with a smaller number of steps while checking the program information. Thus, the burden of executing operations imposed upon the viewer can be lightened.

### Fourth Embodiment

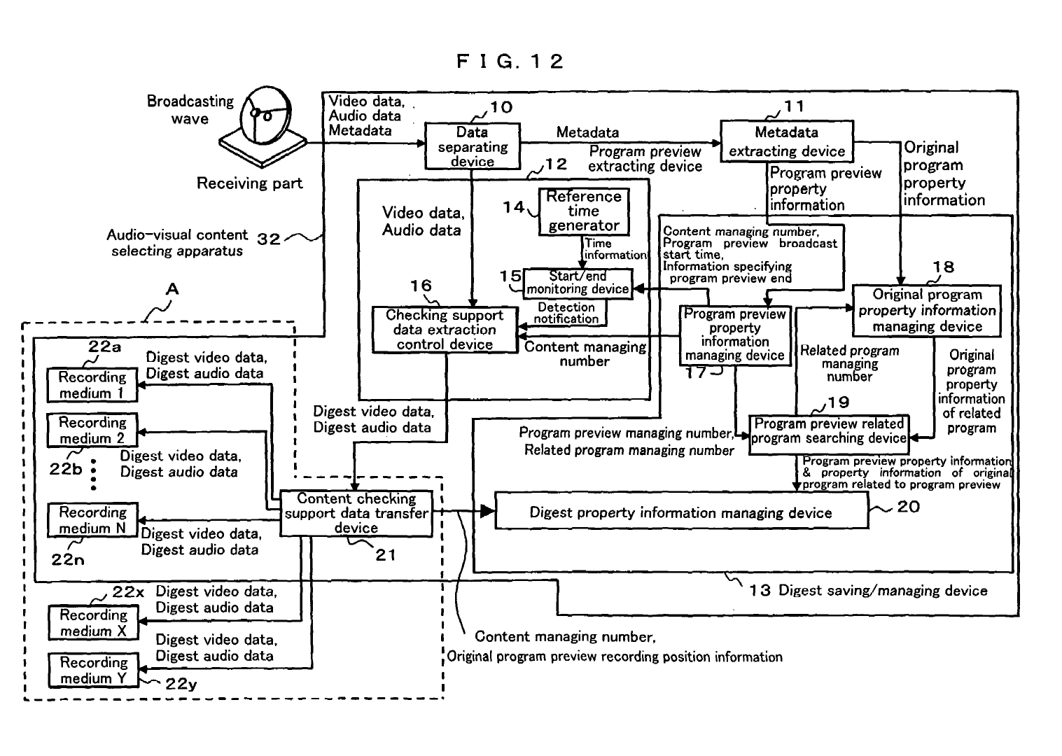

A fourth embodiment of the present invention is a technique for transferring an extracted digest to a recording medium that is selected from a plurality of recording media. FIG. 12 is a block diagram for showing the structure of an audio-visual content selecting apparatus according to the fourth embodiment of the present invention. In FIG. 12, the same reference numerals as those of FIG. 1 according to the first embodiment indicate the same structural elements. The peculiar structures of this embodiment are as follows. In FIG. 12, the content checking support data transfer device 21 is connected to a plurality of recording media for recording the program preview video data and the program preview audio data.

In FIG. 12, reference numerals from 22a, 22b, to 22n are recording media that are connected to the content checking support data transfer device 21 within the same equipment. Further, reference numerals 22x and 22y are recoding media that are connected externally to the content checking support data transfer device 21. As described, the recording media provided within the same equipment and outside thereof are connected to the content checking support data transfer device 21.

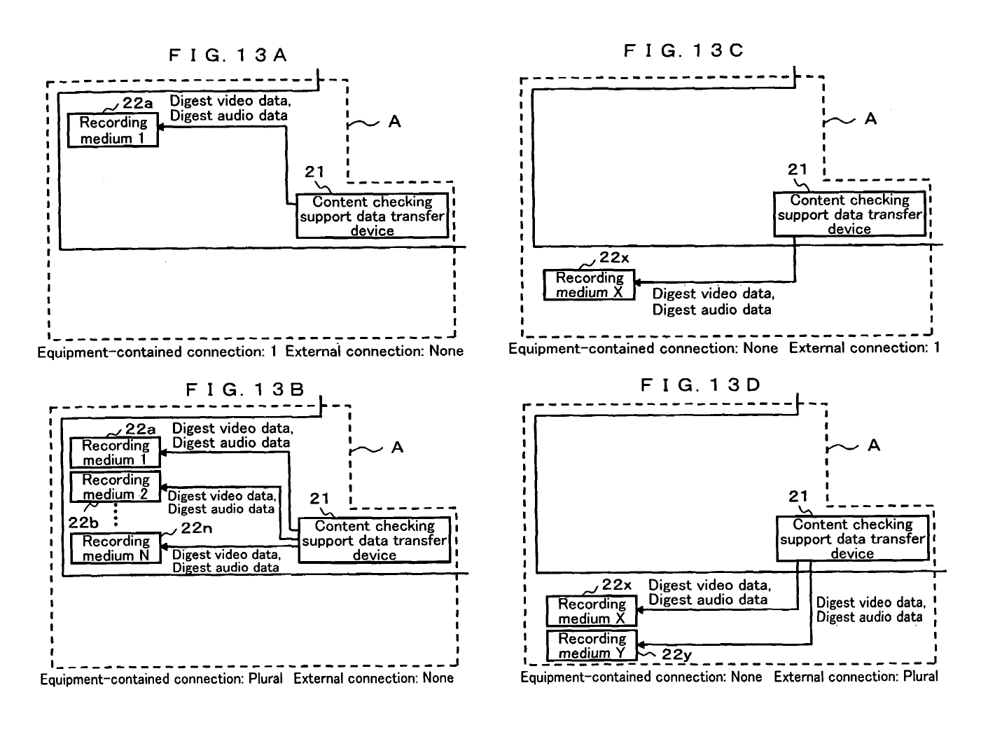

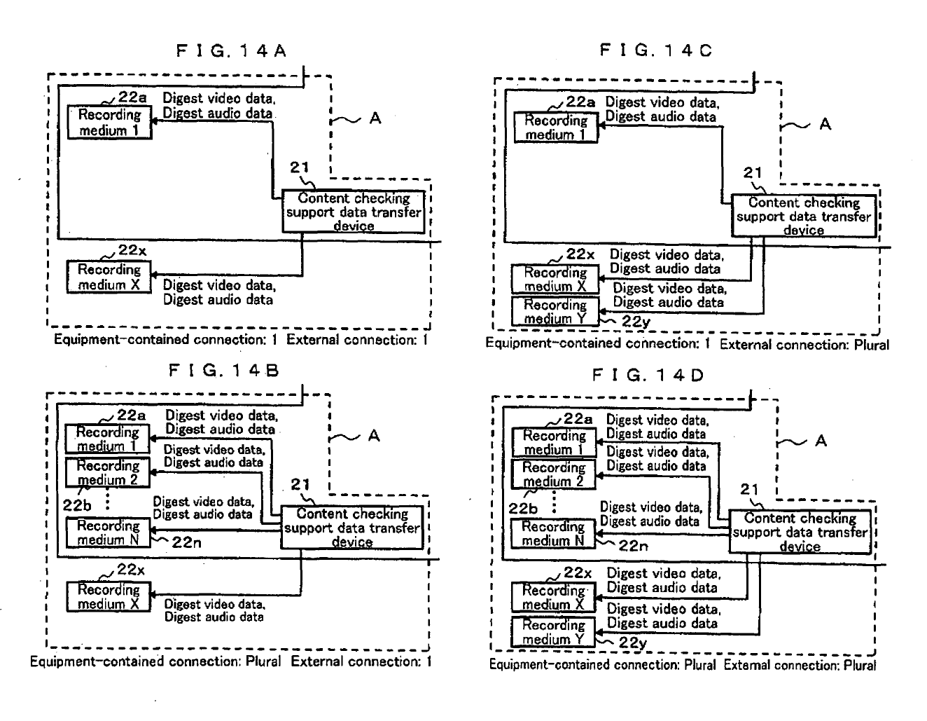

The recording media 22a-22y may be physically isolated recording media or a single recording medium that is divided into a plurality of logic partitions. For the connection form of the content checking support data transfer device 21 and the recording media within an area indicated by “A” in FIG. 12, eight kinds of forms shown in FIG. 13A-FIG. 13D and in FIG. 14A-FIG. 14D are considered.

FIG. 13A shows a form in which a single recording medium provided within the same equipment is connected to the audio-visual content selecting apparatus. FIG. 13B shows a form in which a plurality of recording media provided within the same equipment are connected to the audio-visual content selecting apparatus. FIG. 13C shows a form in which a single recording medium provided outside the apparatus is connected to the audio-visual content selecting apparatus. FIG. 13D shows a form in which a plurality of recording media provided outside the apparatus are connected to the audio-visual content selecting apparatus. FIG. 14A shows a form in which a single recording medium provided within the same equipment and a single recording medium provided outside the apparatus are connected to the audio-visual content selecting apparatus. FIG. 14B shows a form in which a plurality of recording media provided within the same equipment and a single recording medium provided outside the apparatus are connected to the audio-visual content selecting apparatus. FIG. 14C shows a form in which a single recording medium provided within the same equipment and a plurality of recording media provided outside the apparatus are connected to the audio-visual content selecting apparatus. FIG. 14D shows a form in which a plurality of recording media provided within the same equipment and a plurality of recording media provided outside the apparatus are connected to the audio-visual content selecting apparatus.

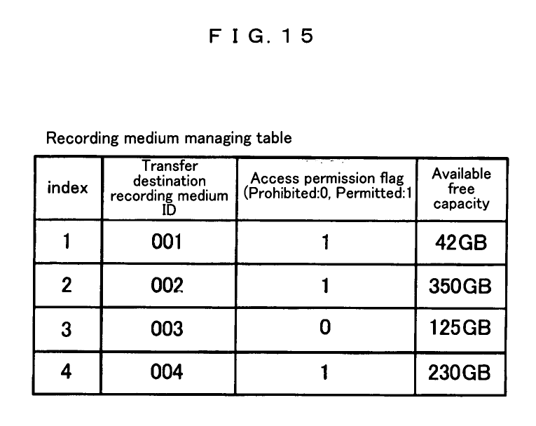

Next, the data structure for managing the recording media will be described. The recording media are connected to the content checking support data transfer device 21. FIG. 15 shows a recording medium managing table that is managed by the content checking support data transfer device 21. The recording medium managing table manages, for each recording medium, “transfer destination recording medium ID” for identifying the recording media, “access permission flag” for the transfer destination recording medium ID, and “available free capacity” in the transfer destination recording medium ID. The “access permission flag” is used for controlling the processing of permitting or prohibiting writing of the program preview video data and the program preview audio data from the content checking support data transfer device 21. In the following cases, the category of the “access permission flag” in the recording medium managing table is changed as appropriate.
When the user explicitly gives an instruction to prohibit writing,
When the recording medium is inserted or removed to/from a recording medium reading/writing device,
When a power supply to the recording medium is ON/OFF switched, or
When a recording region is reserved because recording of the video data and the audio data is reserved by another apparatus in advance for the recording medium that is connected outside the apparatus

Further, the “access permission flag” may be used for exclusively controlling an access to a recording medium, when there is a possibility that accesses to the recording media may be made from a plurality of apparatuses.

The “access permission flag” may be used not only for writing control but also for reading control. Further, in the case of FIG. 15, the access permitted state is expressed with “1”, and the access prohibited state with “0”. However, it may be loaded as a flag other than expressing such states with numerical values to execute ON/OFF control. Furthermore, in the case of FIG. 15, “available free capacity” is managed by the recording size on the recording medium. However, it may be managed by the recordable time information instead of the recording size or by referring to the information on a difference between the total capacity of the recording medium and the currently used capacity. For convenience sake, the embodiment will be described on an assumption that there is an identifier called an index, which is given to each recording medium in an ascending order, when the recording media are registered in the recording medium managing table.

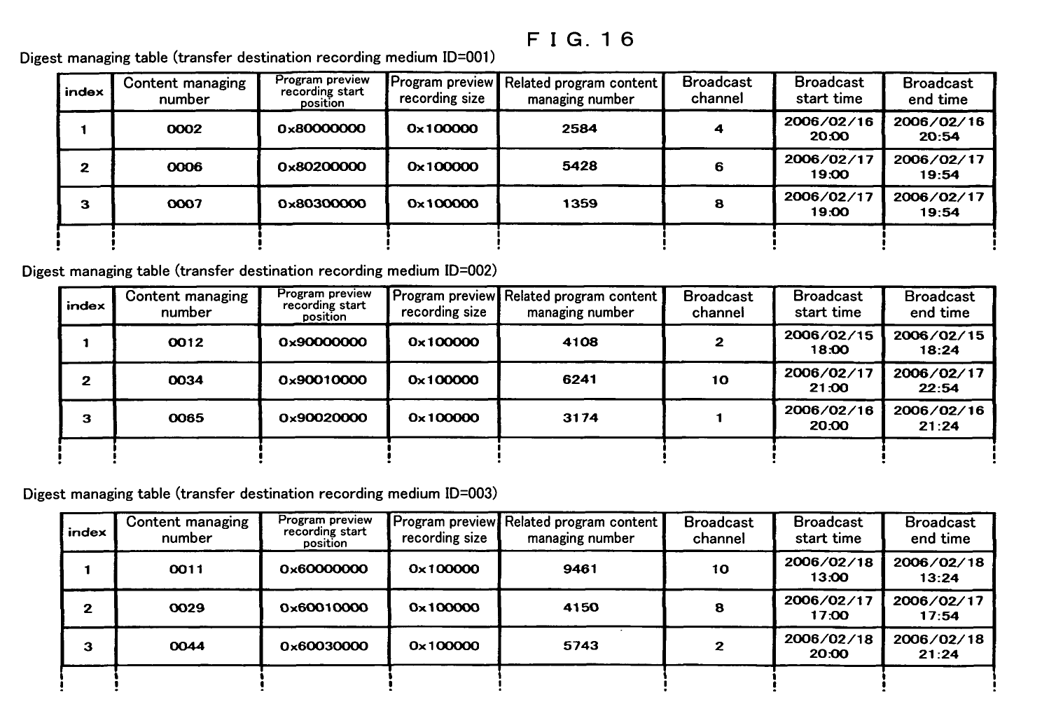

FIG. 16 shows the data structure of the digest managing table. The digest managing table is a table which manages the program preview property information and the original program property information for each of the recording media that are connected to the content checking support data transfer device 21.

The digest managing table manages the following.
Content managing number for specifying the program preview,
Program preview recording start position which shows the recording position when the program preview video data/audio data corresponding to the content managing number is recorded on the recording medium,
Program preview recorded size which shows the recording size of the program preview video data/audio data,
Related program content managing number that is an ID for specifying the original program that is related to the program preview, and
Broadcast channel of the original program, the broadcast start time of the original program, and the broadcast end time of the original program

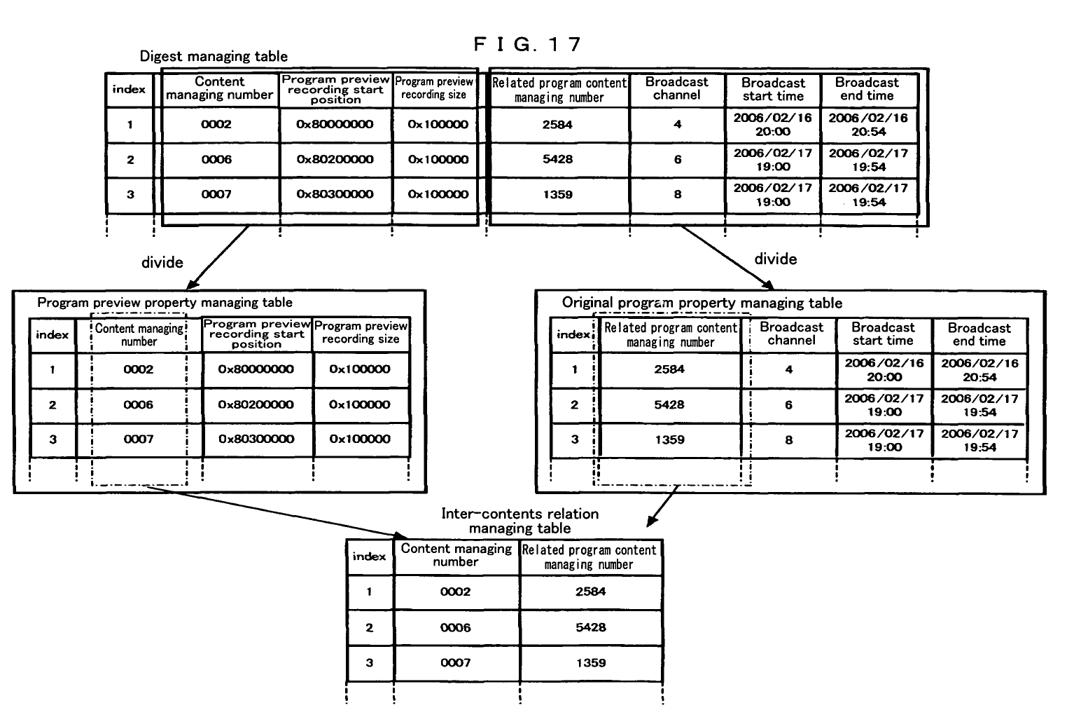

As shown in FIG. 17, the digest managing table may be divided for management purpose into a plurality of tables as follows:
A table for managing the program preview property information,
A table for managing the original program property information, and
An inter-content managing table for managing the program preview and the original program by relating one to the other

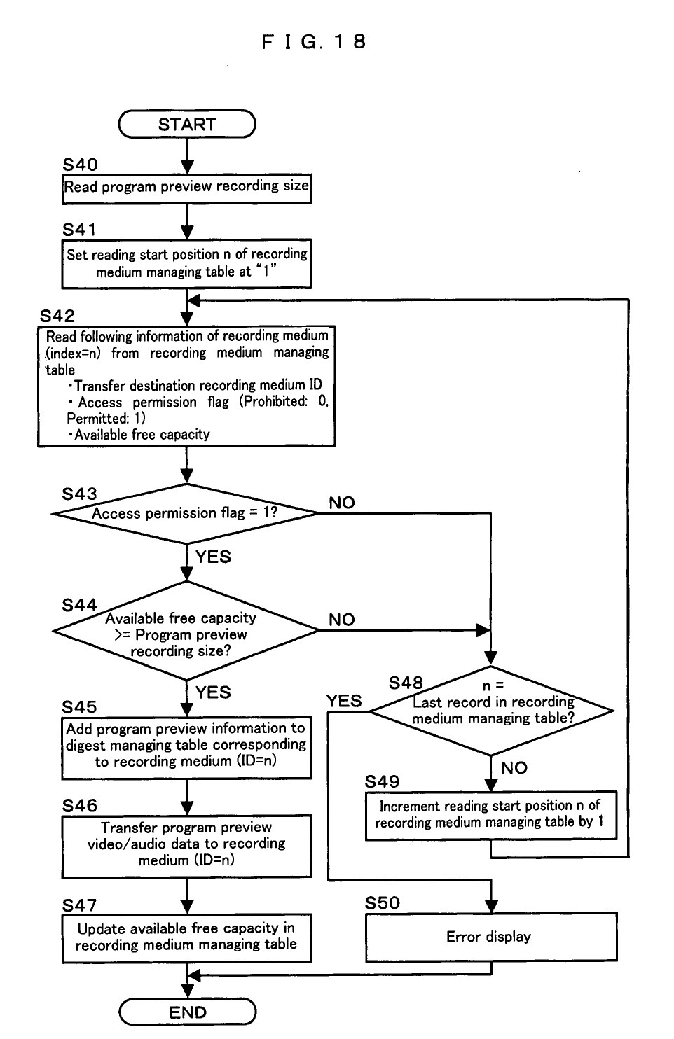

Next, the operation of the audio-visual content selecting apparatus according to the embodiment constituted as described above will be described. FIG. 18 is a flowchart for showing an example of procedures of processing performed in the content checking support data transfer device 21. In this embodiment, described are procedures of transferring and recording the program preview video data and the program preview audio data to the recording medium that is judged first as a recordable recording medium among a plurality of recording media connected to the content checking support data transfer device 21.

In step S40, the program preview recording size is read from the digest managing table of the recording target program preview whose program preview video data/the program preview audio data is measured at the time of extraction. In step S41, the point with the index of n=1 in the recording medium managing table is designated as the reading start position of the record of the recording medium managing table. In step S42, the information on the transfer destination recording medium ID, the access permission flag, and the available free capacity are read out from the record of the recording medium managing table, which corresponds to the index=n of the recording medium managing table. In the case where the recording medium corresponding to the transfer destination recording medium ID is selected as the transfer destination candidate of the program preview video data/the program preview audio data, it is judged in step S43 whether or not the recording medium is in an access permitted state based on the value of the flag indicating the access state. In the case where the recording medium corresponding to the transfer destination recording medium ID is selected as the transfer candidate of the program preview video data/the program preview audio data, it is judged in step S44 whether or not the total data amount of the program preview video data and the program preview audio data can be recorded on the recording medium by comparing it to the available free capacity of the recording medium.

When judged as a result of judgments in the step S43 and the step S44 that the recording medium corresponding to the transfer destination recording medium ID is capable of recording, the program preview and original program information is added to the digest managing table that corresponds to the recording medium ID=n in step S45. In step S46, the program preview video data/the program preview audio data corresponding to the program preview that has been added to the digest managing table in the step S45 is transferred to and recorded on the designated recording medium. In step S47, the free capacity of the recording medium after recording the program preview in the step S46 is updated.

In the meantime, when judged as a result of judgments in the step S43 and the step S44 that the recording medium corresponding to index=n is not capable of recording the program preview, it is judged whether or not there exists the managing information of other recording media in the recording medium managing table. When it is judged in the step S48 that there exists an unreferred record of the recording medium managing table, the reading position of the recording medium managing information which becomes the next transfer destination candidate is designated in step S49. When it is judged in the step S48 that there is no unreferred record of the recording medium managing table, and the program preview can be recorded on none of the recording media that are registered in the recording medium managing table, error display processing is performed in step S50.

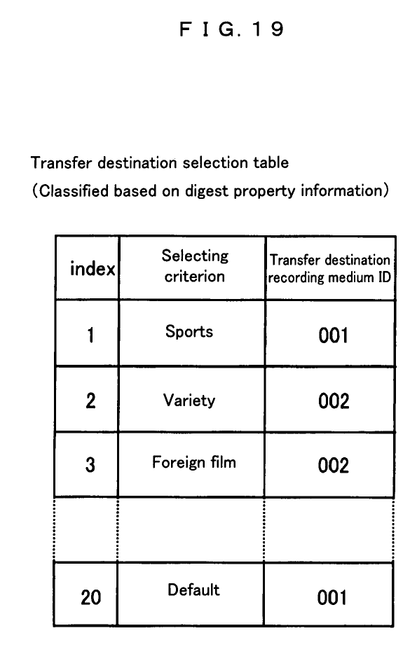

In FIG. 19, judgments on useable recording medium are carried out in ascending order by the index in the recording medium managing table. However, the transfer destination recording medium may be determined by other criteria, for example, by selecting the recording medium in decreasing order available free capacity.

FIG. 19 shows the case of updating the recording medium managing table and the digest managing table when recording the program preview content. FIG. 19 shows the state where the program preview to be recorded is transferred to the recording medium that has the recording medium ID of 001. The digest property information corresponding to the recorded program preview is added to the digest managing table. It should be noted here that the digest managing table is a table that corresponds to the recording medium ID, and the recording medium ID corresponds to the transfer destination selected by the content checking support data transfer device 21. Further, the free capacity equivalent to the data size of the program preview content is subtracted from the section of the available free capacity in a category corresponding to the recording medium ID (0001) of the recording medium managing table.

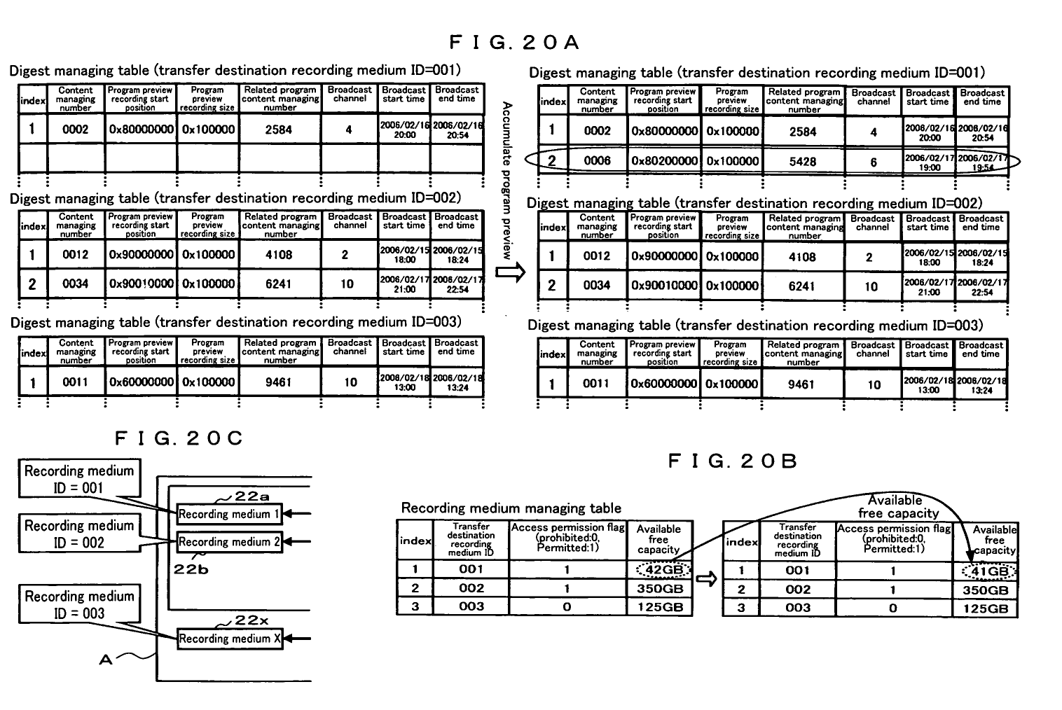

Further, FIG. 20A-FIG. 20C illustrate an example of the digest reproduction list created in the case where a plurality of recording media are being connected. In this case, the control according to the present embodiment can be achieved by adding the recording medium ID corresponding to the program preview of the above-described second embodiment shown in FIG. 8 to the digest program reproduction list, as the information for specifying the program previews that are dispersedly recorded in the plurality of recording media.

With the present embodiment, even in the case where there is a limit in the recording capacity that can be secured in a single recording medium, it is possible to provide a still larger amount of recording capacity through preparing a plurality of recording media within the same equipment and dispersedly recording the program previews. Further, there may be cases where a plurality of recording media cannot be loaded in the same equipment depending on the device layout within the equipment, since there is a physical restriction in the space. However, by connecting the recording medium as an external device, it is possible to ease the physical restriction in the space regarding the recording medium. Furthermore, it becomes possible to extend the recording capacity while using the structure of the existing apparatus. Particularly, it is possible to add the functions of the present invention to the existing apparatus by adding a recording medium as the external device, and replacing the software by downloading software, for example, from the network or the broadcasting wave. Moreover, when there is a free capacity in the recording medium of another apparatus owned by the user, it becomes possible to more effectively share the recording medium between the apparatuses by the use of that recording medium as a recording medium that can be connected externally.

In the fourth embodiment, described is the method which transfers and records the extracted program preview video data and the program preview audio data when the recording medium is judged as recordable. However, as an another method, it is also possible for the content checking support data transfer device 21 to determine transfer destinations to which the program preview video data and the program preview audio data are distributed by using the program preview property information. This method will be described hereinafter.

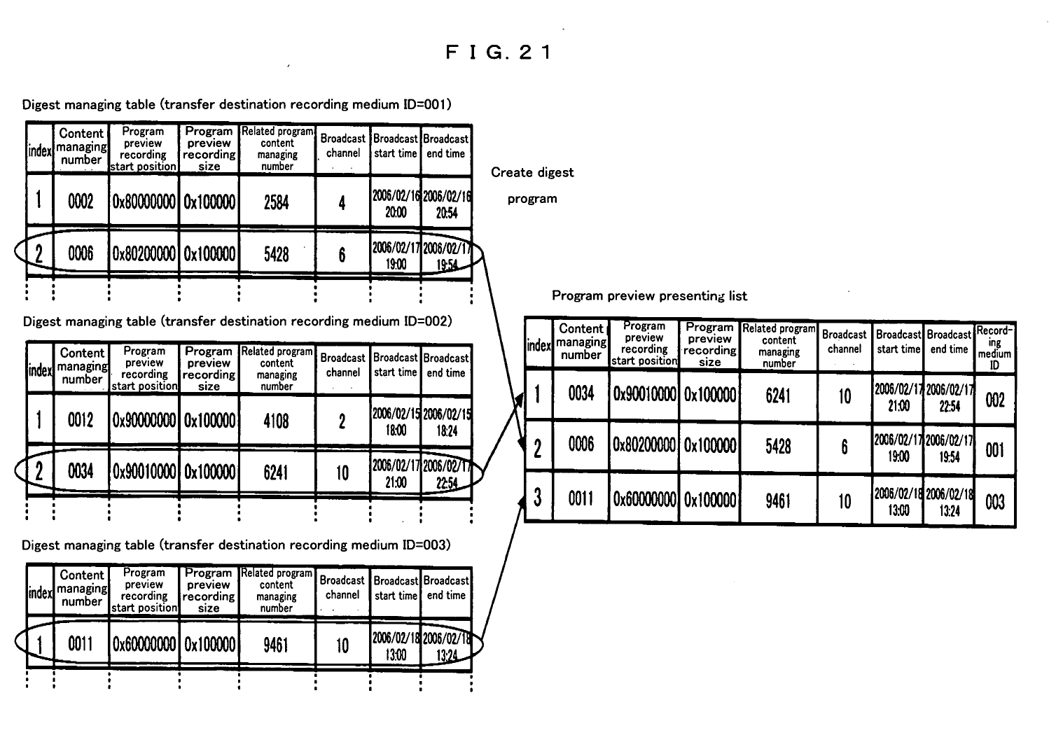

First, described is the data structure of a transfer destination selection table that is referred to for distributing the program previews by the content checking support data transfer device 21. FIG. 21 shows the data structure of the transfer destination selection table that is referred to by the content checking support data transfer device 21. In the transfer destination selection table, a keyword as the selecting criterion and the information on the transfer destination recording medium ID that corresponds to the keyword are managed as a pair of data.

The content checking support data transfer device 21 classifies the transfer destination recording media by paying attention to the specific category of the original program property information, transfers the program preview video data and the program preview audio data to the classified recording media, and performs processing for updating the information on the free capacity of the recording media.

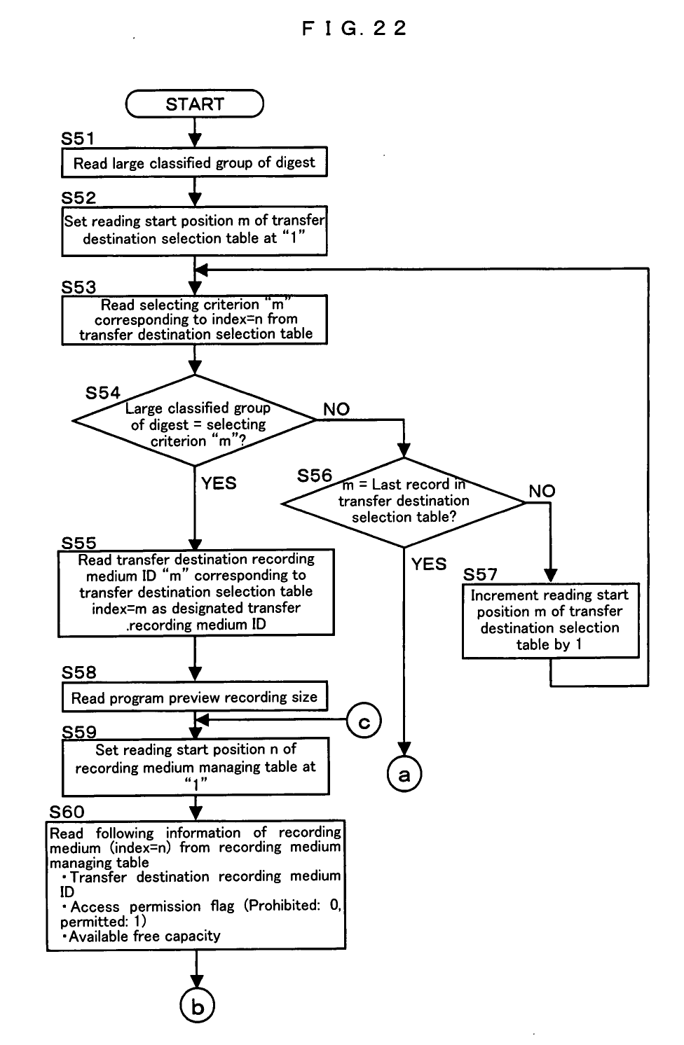

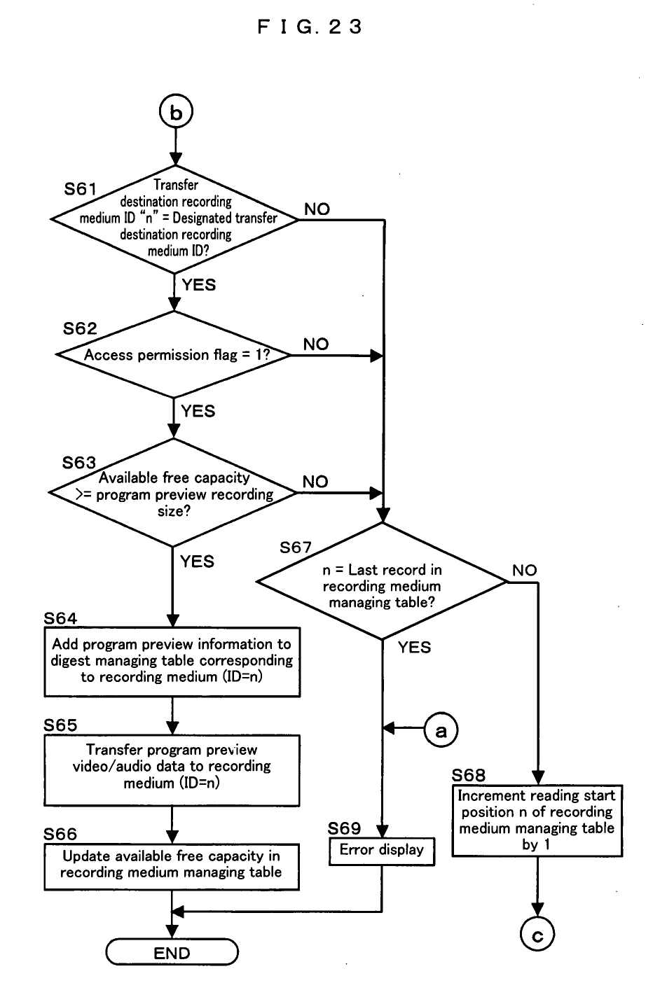

FIG. 22 and FIG. 23 illustrate an example of a flowchart for showing the procedures of the processing for determining the transfer destination recording media, which is performed by the content checking support data transfer device 21 by referring to the transfer destination selection table, after classifying the information specigying original program into a large classified group. In this embodiment, also described is the data transfer/storing processing which is performed when the category of “large classified group” that is held as the original program property information is consistent with the character string that is registered as the selecting criterion of the transfer destination selection table. More specifically, there is described the order of transferring/recording the program preview video data/the program preview audio data to the recording medium that is designated by a plurality of recording media connected to the content checking support data transfer device 21.

In step S51, information of the large classified group is read from the original program property information. In step S52, the reading start position of the transfer destination selection table is set. In this embodiment, the point where the index of the transfer destination selection table is m=1 is designated as the reading start position of the record of the transfer destination selection table. In step S53, the transfer destination selecting criterion at the index=m of the transfer destination selection table is read. In step S54, the large classified group of the original program is compared with the selecting criterion that is read in the step S53. For the comparison between the large classified group and the selecting criterion, judgment is made based on the consistency between the character strings. When judged in the step S54 that the large classified group of the original program is consistent with the selecting criterion, the transfer destination recording medium ID is read in step S55. Meanwhile, when judged in the step S54 that the large classified group of the original program is not consistent with the selecting criterion, it is judged in step S56 whether or not there exists managing information of another recording media in the transfer destination selection table. When judged in the step S56 that there is an unreferred record in the transfer destination selection table, the reading position of the record in the recording managing table which becomes the next selecting criterion candidate is designated in step S57.

In the meantime, after reading the transfer destination recording medium ID in the step S55, the program preview recording size measured at the time of extracting the program preview video data/the program preview audio data is read from the digest managing table of the recording target program preview in step S58. In step S59, the point where the index of the transfer destination selection table is n=1 is designated as the reading start position of the record of the transfer destination selection table. In step S60, the transfer destination recording medium ID, the access permission flag, and the information on the available free capacity are read from the record of the recording medium managing table, which corresponds to the index=n of the recording medium managing table.

In step S61, it is judged whether or not the transfer destination recording medium ID read out in the step S60 is consistent with the transfer destination recording medium ID read out in the step S55. When the recording medium corresponding to the transfer destination recording medium ID is selected as the transfer destination candidate for the program preview video data and the program preview audio data (Yes in step S61), it is judged in step S62 whether or not the recording medium is in an access-permitted state based on the value of the access permission flag. When the recording medium corresponding to the transfer destination recording medium ID is selected as the transfer destination candidate for the program preview video data and the program preview audio data (Yes in step S62), it is judged in step S63 whether or not the total data amount of the program preview video data and the program preview audio data can be recorded on the recording medium by comparing it with the available free capacity of the recording medium. When judged as a result of judgments in the step S62 and the step S63 that the recording medium corresponding to the transfer destination recording medium ID is capable of recording (Yes in both of the steps S62 and S63), the program preview and the original program information is added to the digest managing table that corresponds to the recording medium ID=n in step S64. In step S65, the program preview video data and the program preview audio data corresponding to the program preview that is added to the digest managing table in the step S64 is transferred to and recorded on the designated recording medium. In step S66, the free capacity of the recording medium after recording the program preview in the step S65 is updated.

In the meantime, when judged in the step S62 or the step S63 that the program preview can not be recorded on the recording medium corresponding to the index=n (No in the step S62 or the step S63), it is checked in step S67 whether or not there exists the managing information of another recording medium in the recording medium managing table. When it is judged in the step S67 that there exists an unreferred record in the recording medium managing table (Yes in step S67), the reading position of the recording medium managing information which becomes the next transfer destination candidate is designated in step S68. In step S69, error display processing is performed for the case where the program preview cannot be recorded on the recording medium.

Through executing the transfer destination determination processing shown in FIG. 22 and FIG. 23 by referring to the information on the selecting criterion that is managed in the transfer destination selection table, it becomes easier to specify the recorded recording medium when searching a specific program preview from the accumulated program previews, compared to the procedure of determining the transfer destination recording medium that is shown in FIG. 20.

Further, the program previews are recorded while being classified into groups at the time of accumulation. Thus, for creating the digest program used for performing the viewing/recording reservation of the original program, it becomes easier to create the digest program where the program previews of the same genre are collected.

Furthermore, regarding the procedure for selecting the recording medium to which the extracted program preview video data/the program preview audio data is transferred, it is also possible for the content checking support data transfer device 21 to transfer the program preview video data/the program preview audio data directly to the recording medium that is designated by the user, and to update the information on the free capacity of the recording medium.

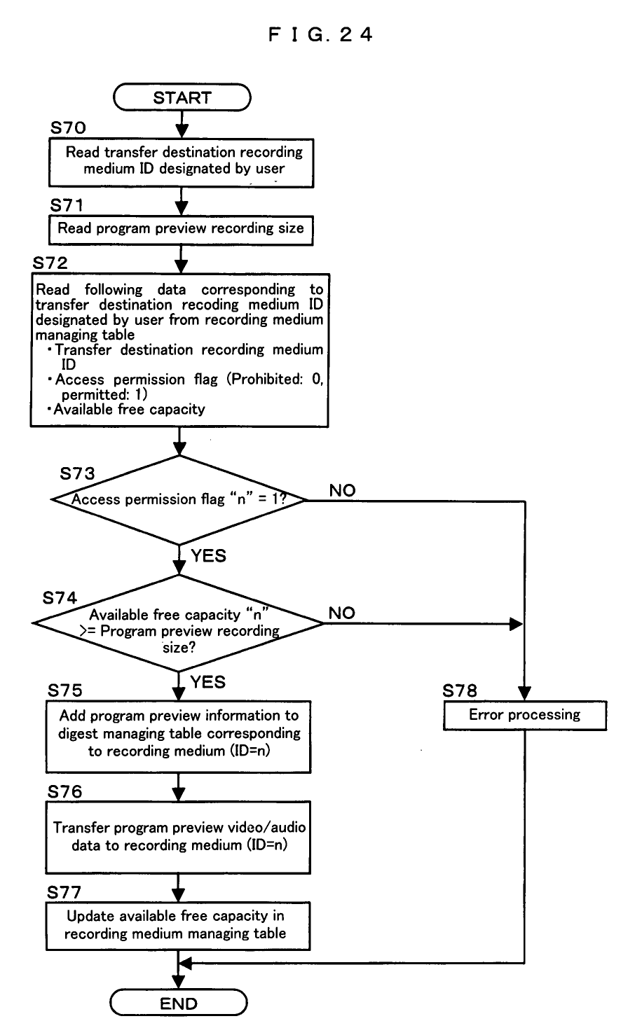

FIG. 24 shows an example of the procedure performed by the content checking support data transfer device 21 for transferring and recording the program preview video data/the program preview audio data to the recording medium that is designated by the user.

As a method for the user to designate the recording medium, there is considered a method where the user selects a single recording medium to be a transfer destination candidate from the menu showing a list of the recording media, for example. However, the transfer destination recording medium may be designated by other methods as well.

In step S70, the transfer destination recording medium ID that corresponds to the transfer destination recording medium designated by the user is read. In step S71, the recording sizes of the program preview video data and the program preview audio data are read. In step S72, the connection state information of the transfer destination recording medium ID designated in the step S70 is searched in the recording medium managing table, and the access permission flag and the information on the available free capacity are read therefrom. In step S73, it is checked whether or not the access permission flag obtained in the step S72 indicates an accessible state. When the access permission flag is “1” in the step S72, it is judged as accessible and the procedure is advanced to step S74. When the flag is “0”, it is judged as inaccessible, i.e. the designated recording medium is under the state where recording of the program preview cannot be performed due to other restrictions. Thus, the procedure is advanced to the error processing in step S78.

In step S74, the available free capacity that is obtained in the step S72 is checked. That is, the recording size of the program preview obtained in the step S71 is compared with the available free capacity. When judged in the step S74 that the available free capacity is larger or equal to the recording size, the procedure is shifted to the recording processing of the program preview that is carried out in step S75 and thereafter. Meanwhile, when judged in the step S74 that the available free capacity is smaller than the recording size of the program review, the procedure is shifted to the error processing in the step S78.

The step S75 is the processing performed when it is judged in the step S73 and the step S74 that the program preview can be recorded on the designated recording medium (Yes in both of the steps S73 and S74). In the step S75, the program preview information is added to the digest managing table that corresponds to the designated recording medium ID. In step S76, the program preview video data/the program preview audio data corresponding to the program preview that is added to the digest managing table in the step S75 is transferred to and recorded on the designated recording medium. In step S77, the free capacity of the recording medium after recording the program preview in the step S76 is updated.

When the program preview cannot be recorded on the designated recording medium (No in the step S73 or the step S74), error processing is performed in the step S78. For the error processing, there may be considered a method which displays that the program preview cannot be recorded and performs no saving processing of the program preview, and a method which defines a recordable recording medium in advance as a default recording medium and records the program preview on that recording medium. However, the error processing may be executed by other methods as well.

If the currently viewing user can be specified, by transferring the program preview to the recording medium that is designated by the user through the procedure shown in FIG. 24, it becomes possible to edit a program preview specialized for a specific user. Therefore, it becomes still easier to create the digest program for viewing/recording reservation of the original program.

Furthermore, when extracted program preview video data and program preview audio data is consistent with or similar to reference information designated by the user in the content checking support data transfer device, as a method for selecting the recording medium to which the extracted program preview video data and the program preview audio data is transferred, it is possible to perform the following procedure. That is, the recording medium is selected by transferring the program preview video data and the program preview audio data to a specific recording medium, and updating the information on the free capacity of that recording medium.

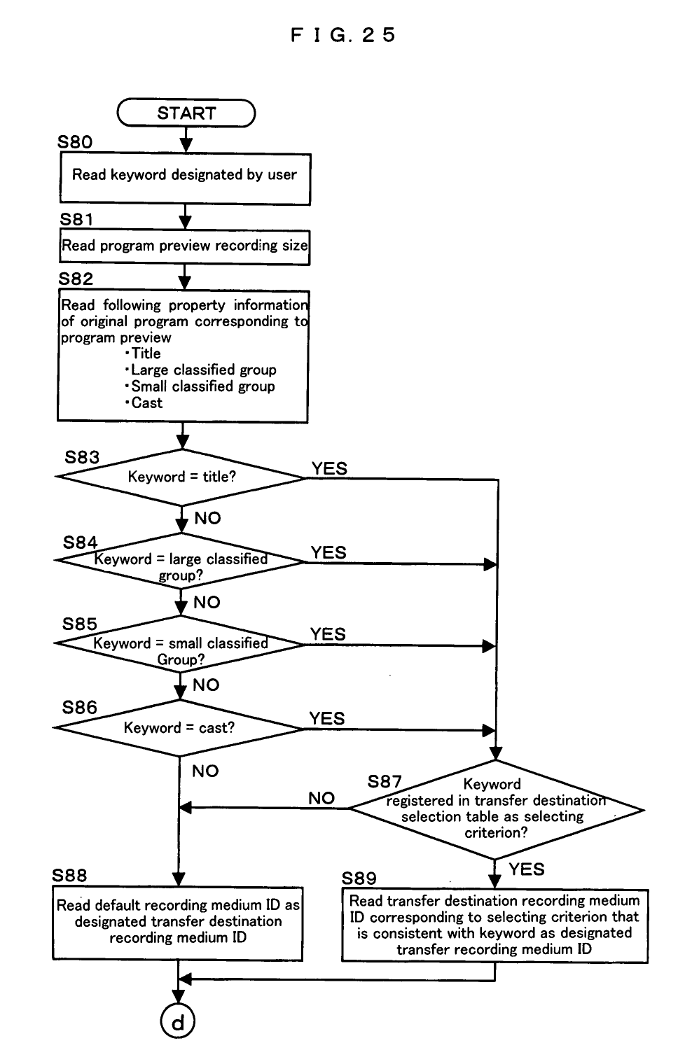

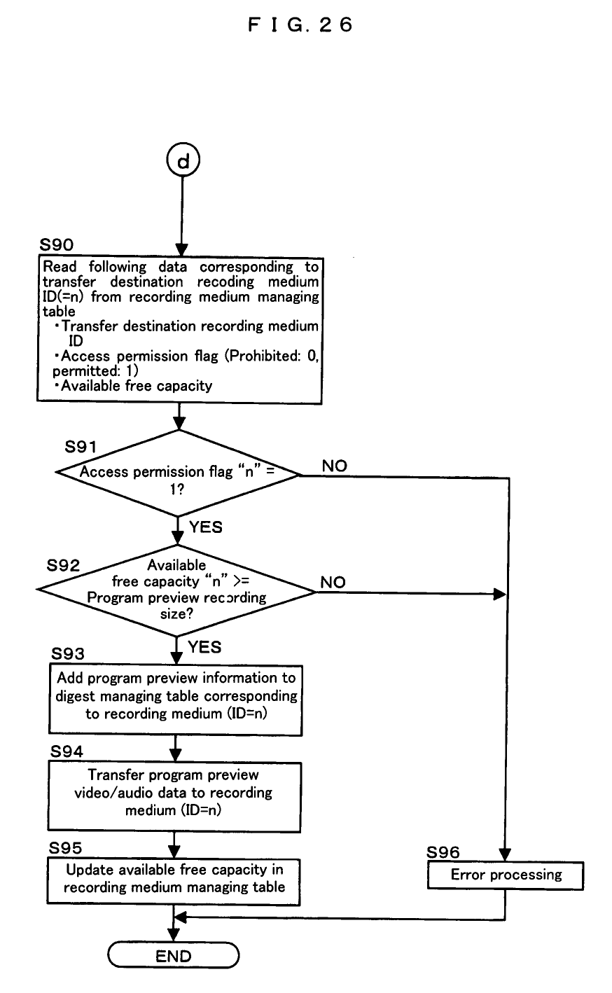

FIG. 25 and FIG. 26 are flowcharts for describing the procedure for transferring/recording the program preview video data and the program preview audio data to a recording medium that corresponds to a keyword. As a method for the user to input the keyword, there is considered a method of inputting characters by operating buttons on a remote controller, for example. However, the keyword may be designated by other methods as well. For explaining the case of the FIG. 25 and FIG. 26, it is assumed that the keyword is designated by referring to the transfer destination selection table shown in FIG. 21.

In step S80, the keyword designated by the user is read. In step S81, the recording size of the program preview video data and the program preview audio data is read. In step S82, the original program property information that corresponds to the program preview is read. In the flows of FIG. 25 and FIG. 26, information on “title”, “large classified group”, “small classified group”, and “cast” is read as the original program property information. However, when other categories are provided in the original program property information, the information corresponding to those categories may be read as well.

In step S83, the keyword designated by the user in the step S80 is compared with the title of the program preview to judge whether or not a part of or the entire title is consistent with the keyword. When judged in the step S83 that there is a consistency, it is considered as the program preview that corresponds to the keyword. Then, the procedure is advanced to step S87. When judged that there is no consistency, it is advanced to step S84.

In the step S84, the keyword designated by the user in the step S80 is compared with the character string that is registered in the “large classified group” of the program preview to judge whether or not the keyword is consistent with a part of or the entire “large classified group. When judged in the step S84 that there is a consistency, it is considered as the program preview that corresponds to the keyword. Then, the procedure is advanced to step S87. When judged that there is no consistency, it is advanced to step S85.

In the step S85, the keyword designated by the user in the step S80 is compared with the character string that is registered in the “small classified group” of the program preview to judge whether or not the keyword is consistent with a part of or the entire “the small classified group. When judged in the step S85 that there is a consistency, it is considered as the program preview that corresponds to the keyword. Then, the procedure is advanced to step S87. When judged that there is no consistency, it is advanced to step S86.

In step S86, the keyword designated by the user in the step S80 is compared with the character string registered to the “cast” of the program preview to judge whether or not the keyword is consistent with the “cast. When judged in the step S86 that there is a consistency, it is considered as the program preview that corresponds to the keyword. Then, the procedure is advanced to step S87. When judged that there is no consistency, it is advanced to step S88.

In step S87, the transfer destination recording medium ID of the program preview that corresponds to the keyword is searched. When judged in the step S87 that there exists the designated keyword in the category of the selecting criterion of the transfer destination selection table, it is advanced to step S89. When judged that there is no designated keyword in the category of the selecting criterion, it is advanced to the step S88.

When judged in the step S87 that there is no recording medium that is related to the keyword, a default recording medium ID that is set in advance is designated as the transfer destination recording medium ID in the step S88. Meanwhile, when judged in the step S87 that there exists the designated keyword in the category of the selecting criterion of the transfer destination selection table, the corresponding recording medium ID is obtained as the transfer destination recording medium ID in step S89.

In step S90, the connection state information of the transfer destination recording medium ID that is designated in the step S88 or the step S89 is searched from the recording medium managing table, and the access permission flag and the available free capacity are obtained.

In step S91, the access permission flag obtained in the step S90 is checked. When judged that the access permission flag is “1”, the procedure is advanced to step S92. When judged as “0”, it is considered that the designated recording medium is under the state where recording of the program preview cannot be performed due to other restrictions. Thus, the procedure is advanced to the error processing in step S96.

In step S92, the available free capacity that is obtained in the step S90 is checked. That is, the recording size of the program preview obtained in the step S90 is compared with the available free capacity. When judged in the step S92 that the available free capacity is larger or equal to the recording size, the procedure is shifted to the recording processing of the program preview that is executed in step S93 and thereafter. Meanwhile, when judged in the step S92 that the available free capacity is smaller, the procedure is shifted to the error processing in the step S96.

The step S93 is the processing performed when it is judged in the step S91 and the step S92 that the program preview can be recorded on the designated recording medium (Yes in both of the steps S91 and S92). In the step S93, the program preview information is added to the digest managing table that corresponds to the designated recording medium ID. In step S94, the program preview video data/the program preview audio data corresponding to the program preview that is added in the step S93 is transferred to and recorded on the designated recording medium. In step S95, the free capacity of the recording medium after recording the program preview in the step S94 is updated.

When the program preview cannot be recorded on the designated recording medium (No in the step S91 or the step S92), error processing is performed in the step S96. For the error processing, there may be considered a method which displays that the program preview cannot be recorded and performs no saving processing of the program preview, and a method which defines a recordable recording medium in advance as a default recording medium and records the program preview on that recording medium. The error processing may be executed by any of the methods.

The following effects can be obtained by determining the transfer destination of the program preview by having the keyword that is designated by the user through the procedure shown in FIG. 25 and FIG. 26 as the selecting criterion. That is, since the above-described keyword reflects the information on the preference of the user, it is possible to create the digest program in which the user's preference is more reflected, to be used for performing the viewing/recording reservation of the original program, by extracting the program preview from the recording media that are set as the selections for the transfer destinations.

The present invention has been described in detail by referring to the most preferred embodiments. However, various combinations and modifications of the components are possible without departing from the spirit and the broad scope of the appended claims.

What is claimed is:

1. An audio-visual content selecting circuit, comprising:
a data separating device which separates video data, audio data, and metadata from a multiplexed broadcasting signal;
a metadata extracting device for extracting program preview property information and original program property information from said metadata;
a program preview extracting device which extracts a program preview content of an original program preview at least from either said video data or said audio data based on said program preview property information, and records the extracted program preview content on a recording medium as content checking support data; and
a digest saving/managing device which generates at least a single digest by relating said program preview property information, said original program property information, and said content checking support data, and saves/manages said digest.

2. The audio-visual content selecting circuit according to claim 1, further comprising:
a digest program editing device which selects a single or two or more of said digests that are necessary from at least one of said digests that are saved/managed in said digest saving/managing device, and generates a digest program and information regarding said digest program from the selected digest;
an interface provided between said recording medium for recording said content checking support data and said audio-visual content selecting circuit;
a digest program reproduction request device for making a reproduction request of said digest program;
a digest program reproduction control device which performs control on the processing of reading out and reproducing content checking support data regarding said digest program from said recording medium via said interface according to said reproduction request, based on information regarding said digest program in said digest program editing device;
a decoder for decoding said content checking support data regarding said digest program that is read out from said recording medium; and
an output device for outputting, to outside, said content checking support data that was decoded.

3. The audio-visual content selecting circuit according to claim 2, wherein:
a plurality of said recording media are provided; and
said interface selects an arbitrary recording medium from said plurality of recording media, and transfers said content checking support data to said recording medium that was selected.

4. The audio-visual content selecting circuit according to claim 2, further comprising:
a digest designating device which accepts an input from a user for designating an arbitrary digest, based on content checking support data regarding said digest program that is being reproduced; and
a reservation managing device which manages a recording reservation or a viewing reservation by referring to said original program property information of a related program that corresponds to said digest that is designated in said digest designating device.

5. The audio-visual content selecting circuit according to claim 1, wherein said metadata extracting device extracts, from said metadata: a content managing number for managing property information of said content; a related program content managing number for managing said content that corresponds to said related program; and a broadcast channel, broadcast start time, and information specifying program end of said content that corresponds to said related program.

6. The audio-visual content selecting circuit according to claim 1, wherein, when judged that said content property information extracted by said metadata extracting device is a program preview, said program preview extracting device starts extraction of said program preview content at a point where the current time reaches the broadcast start time of said content corresponding thereto, and ends extraction of said program preview content at a point where it has filled a condition that is calculated from said information specifying program end of the corresponding content.

7. The audio-visual content selecting circuit according to claim 1, wherein said digest saving/managing device comprises:
a program preview property information managing device which manages the content property information, when it is judged that said content property information extracted by said metadata extracting device is a program preview;
an original program property information managing device which manages the content property information, when it is judged that said content property information extracted by said metadata extracting device is an original program;
a program preview related program searching device which detects whether or not a related program content managing number of a program preview in said program preview property information managing device is consistent with an original program content managing number in said original program property information managing device; and
a digest property information managing device which, when said program preview related program searching device detects that said numbers are consistent, manages: a content managing number in said program preview property information managing device; a related program content managing number in said original program property information managing device; a broadcast channel, broadcast start time, and information specifying program end of a related original program; and a recording position of said content checking support data in said recording medium that corresponds to said content managing number.

8. The audio-visual content selecting circuit according to claim 1, wherein, when a part of or the entire program preview related program information of a digest that is already being managed in said digest saving/managing device is consistent with program preview related program information that is extracted anew by said program preview extracting device, said digest saving/managing device excludes said digest that is extracted anew from a saving/managing target.

9. The audio-visual content selecting circuit according to claim 1, wherein said content checking support data is at least either program preview video data or program preview audio data, or both.

10. An audio-visual content selecting apparatus, comprising:
a data separating device which separates video data, audio data, and metadata from a multiplexed broadcasting signal;
a metadata extracting device for extracting program preview property information and original program property information from said metadata;
a program preview extracting device which extracts a program preview content of an original program preview as content checking support data at least from either said video data or said audio data based on said program preview property information;
a digest saving/managing device which generates at least a single digest by relating said program preview property information, said original program property information, and said content checking support data, and saves/manages said digest; and
a content checking support data transfer device for transferring said content checking support data to a recording medium.

11. The audio-visual content selecting apparatus according to claim 10, wherein:
a plurality of said recording media are provided; and
said content checking support data transfer device selects an arbitrary recording medium from said plurality of recording media, and transfers said content checking support data to said recording medium that was selected.

12. The audio-visual content selecting apparatus according to claim 11, wherein said recording media are connected within the same equipment via said content checking support data transfer device.

13. The audio-visual content selecting apparatus according to claim 11, wherein said recording media are connected to external equipment via said content checking support data transfer device.

14. The audio-visual content selecting apparatus according to claim 11, wherein said content checking support data transfer device selects said recording medium by referring to said program preview property information.

15. The audio-visual content selecting apparatus according to claim 11, wherein said content checking support data transfer device selects said recording medium by referring to reference data that is designated by a user, in addition to said program preview property information.

16. The audio-visual content selecting apparatus according to claim 10, comprising:
a digest program editing device which selects, from said digests, a single or two or more of said digests, and generates a selected-digest program and information regarding said digest program;
a digest program reproduction request device for making a reproduction request of said digest program;
a digest program reproduction control device which performs control on the processing of reading out and reproducing content checking support data regarding said digest program from said recording medium according to said reproduction request, based on information regarding said digest program in said digest program editing device; and
a decoder for decoding content checking support data regarding said digest program that is read out from said recording medium.

17. The audio-visual content selecting apparatus according to claim 16, further comprising:
a digest designating device which accepts an input from a user for designating an arbitrary digest, based on said content checking support data that is being reproduced; and
a reservation managing device which manages a recording reservation or a viewing reservation by referring to said original program property information of a program that corresponds to said digest that is designated in said digest designating device.

18. The audio-visual content selecting apparatus according to claim 10, wherein said metadata extracting device extracts, from said metadata: a content managing number for managing property information of said content; a related program content managing number for managing said content that corresponds to said program that is related; and a broadcast channel, broadcast start time, and information specifying program end of said content that corresponds to said related program.

19. The audio-visual content selecting apparatus according to claim 10, wherein, when judged that said content property information extracted by said metadata extracting device is a program preview, said program preview extracting device starts extraction of said program preview content at a point where the current time reaches the broadcast start time of said content corresponding thereto, and ends extraction of said program preview content at a point where it has filled a condition that is calculated from said information specifying program end of the corresponding content.

20. The audio-visual content selecting apparatus according to claim 10, wherein said digest saving/managing device comprises:
a program preview property information managing device which manages the content property information, when it is judged that said content property information extracted by said metadata extracting device is a program preview content;
an original program property information managing device which manages the content property information, when it is judged that said content property information extracted by said metadata extracting device is an original program; and
a program preview related program searching device which detects whether or not a related program content managing number of a program preview in said program preview property information managing device is consistent with an original program content managing number in said original program property information managing device, and excludes said digest that is extracted anew from a saving/managing target when judged that a part of or the entire program preview related program information of a digest that is already being managed is consistent.

21. The audio-visual content selecting apparatus according to claim 10, wherein said content checking support data is at least either program preview video data or program preview audio data, or both.

22. An audio-visual content recording support apparatus, comprising:
said audio-visual content selecting apparatus according to claims 10; and
a digest property information managing device which manages: a related program content managing number in said original program property information managing device; a broadcast channel, broadcast start time, and information specifying program end of a related original program; a content managing number in said program preview property information managing device; and a recording position of said content checking support data in said recording medium that corresponds to said content managing number.
